(19) United States
(12) Patent Application Publication
(10) Pub. No.: US 2025/0306442 A1
(43) Pub. Date: Oct. 2, 2025

(54) PROJECTOR AND PROJECTION SYSTEM

(71) Applicant: SEIKO EPSON CORPORATION, Tokyo (JP)

(72) Inventors: Eiji Morikuni, Matsumoto-shi (JP); Koya Shiratori, Matsumoto-shi (JP)

(73) Assignee: SEIKO EPSON CORPORATION, Tokyo (JP)

(21) Appl. No.: 19/093,899

(22) Filed: Mar. 28, 2025

(30) Foreign Application Priority Data
Mar. 29, 2024 (JP) 2024-055572

(51) Int. Cl. G03B 21/00; G02F 1/1335; G03B 21/20

(52) U.S. Cl. CPC G03B 21/006; G02F 1/133504; G02F 1/133512; G02F 1/133528; G03B 21/2066

(57) ABSTRACT

A projector includes: a light source device unit configured to emit invisible light and visible light containing first light having a first wavelength; an optical element configured to emit first combined light containing first light and invisible light; a first liquid crystal panel configured to modulate first combined light; a first incident-side polarizing plate configured to transmit first light on a light incident side of first liquid crystal panel; a first emission-side polarizing plate configured to transmit first light on a light emission side of first liquid crystal panel; and a projection optical system configured to project first combined light emitted from first liquid crystal panel, in which optical element functions as at least one light separation element that separates, from visible light, light having a wavelength different from first wavelength or light combining element that combines first light and invisible light, and invisible light is reflected by optical element.

The present application is based on, and claims priority from JP Application Serial Number 2024-055572, filed Mar. 29, 2024, the disclosure of which is hereby incorporated by reference herein in its entirety.

### BACKGROUND

### 1. Technical Field

The present disclosure relates to a projector and a projection system.

### 2. Related Art

In an image display device such as a projector, in order to control a visible image to be displayed, the visible image and an invisible image such as an infrared image may be superimposed on a screen, and the control may be performed based on information that can be acquired from the invisible image. For example, JP-A-2008-176195 discloses a projector that separates infrared light from light emitted from a light source, and superimposes the infrared light on a projection image via a dedicated light modulation element.

In the device disclosed in the above-described JP-A-2008-176195, an optical path of invisible light is arranged at a position different from an optical path of visible light. Therefore, there is a problem that movement or deviation of a projection image caused by a factor on optical paths of visible light of various colors cannot be accurately reproduced on an optical path of the invisible light, and it is difficult to accurately adjust the projection image.

### SUMMARY

In order to solve the above problem, a projector according to a first aspect of the present disclosure includes: a light source device unit configured to emit invisible light and visible light containing first light having a first wavelength; an optical element configured to emit first combined light containing the first light and the invisible light; a first liquid crystal panel configured to modulate the first combined light; a first incident-side polarizing plate configured to transmit the first light on a light incident side of the first liquid crystal panel; a first emission-side polarizing plate configured to transmit the first light on a light emission side of the first liquid crystal panel; and a projection optical system configured to project the first combined light emitted from the first liquid crystal panel, in which the optical element functions as at least one of a light separation element t light having a wavelength different from the first wavelength from the visible light or a light combining element that combines the first light and the invisible light, and the invisible light is reflected by the optical element.

A projection system according to a second aspect of the present disclosure includes: the projector; and an imaging device configured to image a projection image of the invisible light projected from the projector, in which the projector includes a movement mechanism configured to move the projection optical system to change a position of the projection image, and a control unit configured to control the movement mechanism based on an image imaged by the imaging device.

A projection system according to a third aspect of the present disclosure includes: the projector; and an imaging device configured to image a projection image of the invisible light projected from the projector, in which the projector includes a control unit configured to change a region of an image formed in an image display region of the first liquid crystal panel based on an image imaged by the imaging device.

### BRIEF DESCRIPTION OF THE DRAWINGS

FIG. 1 is a schematic view showing a projector according to a first embodiment.

FIG. 2 is a schematic plan view showing a light transmitting member according to the first embodiment.

FIG. 3 is a schematic cross-sectional view showing the light transmitting member according to the first embodiment.

FIG. 4 is a graph showing an example of characteristics of an inorganic polarizing plate and an organic polarizing plate.

FIG. 5 is a conceptual diagram showing a polarizing state of first combined light in the projector according to the first embodiment.

FIG. 6 is a schematic view showing a positional relationship between a projection optical system, a first liquid crystal panel, and the light transmitting member in the projector according to the first embodiment.

FIG. 7 is a schematic plan view showing a light transmitting member according to Modification 1.

FIG. 8 is a schematic view showing a projector according to Modification 2.

FIG. 9 is a schematic cross-sectional view showing a depolarizing plate used in the projector according to Modification 2.

FIG. 10 is a schematic view showing a first laser light source and a second laser light source that can be adopted in Modification 2.

FIG. 11 is a diagram showing a polarizing state of light emitted from a light emitting region shown in FIG. 10 on the Poincare sphere.

FIG. 12 is a schematic view showing a projector according to Modification 3.

FIG. 13 is a schematic view showing a projector according to Modification 4.

FIG. 14 is a schematic view showing a projection system according to Modification 5, and showing a projection image in an initial state or after image correction is performed.

FIG. 15 is a schematic view showing the projection system according to Modification 5, and showing a projection image before image correction is performed.

FIG. 16 is a schematic view showing a projector according to a third embodiment.

### DESCRIPTION OF EMBODIMENTS

Hereinafter, an embodiment of the present disclosure will be described with reference to the drawings.

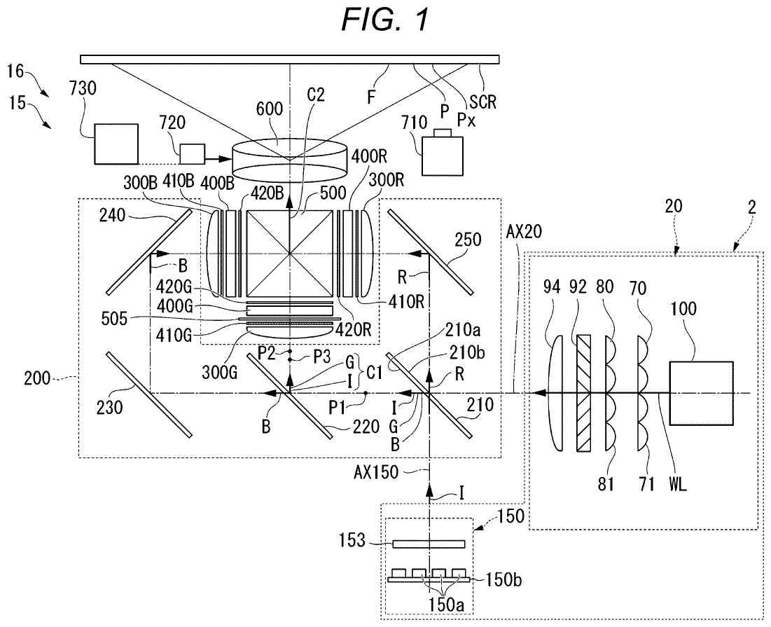

FIG. 1 is a schematic view showing a configuration of a projection system 16 according to the embodiment. In the following drawings, components may be drawn at different dimensional scales for clarity of the components.

### First Embodiment

### Projection System

The projection system 16 includes a projector 15 and an imaging device 710. The projector 15 projects a projection image P of visible light and a projection image Px of infrared light I including a predetermined pattern F in a superimposed manner on a screen SCR disposed in front of the projector 15. The configuration of the projector 15 will be described in detail later.

The imaging device 710 is, for example, a camera including an imaging element that can image the infrared light I. The imaging device 710 is disposed outside the projector 15, and is coupled to the projector 15 in a wired or wireless manner. The imaging device 710 is disposed at a position where the imaging device 710 does not block light projected from the projector 15. Alternatively, the imaging device 710 may be incorporated inside the projector 15.

The imaging device 710 images the projection image P projected by the projector 15. As will be described later, the projection image P is formed by second combined light C2 obtained by combining visible light and the infrared light I which is invisible light. Therefore, the projection image Px of the infrared light I is superimposed on the projection image P. The imaging device 710 images the projection image Px of the infrared light I. A control unit 730 of the projector 15 is coupled to the imaging device 710. The control unit 730 corrects a position of the projection image P based on the projection image Px of the infrared light I imaged by the imaging device 710.

In the present specification, the visible light is, for example, light having a wavelength of 360 nm or more and 830 nm or less. The invisible light is, for example, ultraviolet light having a wavelength of less than 360 nm or red light having a wavelength of more than 830 nm. Although the infrared light I is used as the invisible light in the embodiment, ultraviolet light may be used as the invisible light.

### Projector

As shown in FIG. 1, the projector 15 includes a light source device unit 2, a color separation optical system 200, field lenses 300R, 300G, and 300B, liquid crystal panels 400R, 400G, and 400B, incident-side polarizing plates 410R, 410G, and 410B, emission-side polarizing plates 420R, 420G, and 420B, a light transmitting member 505, a cross dichroic prism (first light combining element) 500, a projection optical system 600, a movement mechanism 720, and the control unit 730.

In the following description, when the plurality of liquid crystal panels 400R, 400G, and 400B are distinguished from one another, they are referred to as the first liquid crystal panel 400G, the second liquid crystal panel 400R, and the third liquid crystal panel 400B. When the plurality of incident-side polarizing plates 410R, 410G, and 410B are distinguished from one another, they are referred to as the first incident-side polarizing plate 410G, the second incident-side polarizing plate 410R, and the third incident-side polarizing plate 410B. When the plurality of emission-side polarizing plates 420R, 420G, and 420B are distinguished from one another, they are referred to as the first emission-side polarizing plate 420G, the second emission-side polarizing plate 420R, and the third emission-side polarizing plate 420B.

### Light Source Device Unit

The light source device unit 2 includes a visible light source device 20 that emits visible light and an invisible light source device 150 that emits invisible light. In the embodiment, the visible light emitted by the visible light source device 20 is white light WL obtained by combining red light R, green light G, and blue light B. In the embodiment, the green light G is first light having a first wavelength. The red light R is second light having a second wavelength different from the first wavelength. The blue light Bis third light having a third wavelength different from both the first wavelength and the second wavelength. The first wavelength may be a wavelength range that is visually recognized as the green light G, the second wavelength may be a wavelength range that is visually recognized as the red light R, and the third wavelength may be a wavelength range that is visually recognized as the blue light. The invisible light emitted by the invisible light source device 150 is the infrared light I. The invisible light source device 150 may emit ultraviolet light as the invisible light.

### Visible Light Source Device

The visible light source device 20 includes a light source unit 100, a first lens array 70, a second lens array 80, a polarization conversion element 92, and a superimposing lens 94. The light source unit 100 outputs the white light WL. The white light WL emitted from the light source unit 100 is collimated and is incident on the first lens array 70.

The first lens array 70 includes a plurality of small lenses 71 for dividing the white light WL emitted from the light source unit 100 into a plurality of partial light fluxes. The plurality of small lenses 71 are arranged in a matrix in a plane orthogonal to an optical axis AX20 of the light source unit 100.

The second lens array 80 includes a plurality of small lens 81 corresponding to the plurality of small lens 71 of the first lens array 70. The plurality of small lenses 81 are arranged in a matrix in a plane orthogonal to the optical axis AX20. The second lens array 80 forms images of the respective small lenses 71 of the first lens array 70 in the vicinity of respective image forming regions of the liquid crystal panels 400R, 400G, and 400B, together with the superimposing lens 94.

The polarization conversion element 92 includes a polarization separation layer, a reflection layer, and a phase difference plate, none of which is shown. The polarization conversion element 92 converts a partial light flux emitted from the second lens array 80 into linearly polarized light. The polarization conversion element 92 is formed in a plate shape as a whole. A plate surface of the polarization conversion element 92 is disposed parallel to a plane orthogonal to the optical axis AX20. The polarization separation layer of the polarization conversion element 92 transmits one linearly polarized component contained in the partial light flux emitted from the second lens array 80, and reflects the other linearly polarized component in a direction perpendicular to the optical axis AX20. The reflection layer of the polarization conversion element 92 layer reflects the other linearly polarized component reflected by the polarization separation layer in a direction parallel to the optical axis AX20. The phase difference plate of the polarization conversion element 92 converts the other linearly polarized component reflected by the reflection layer into the one linearly polarized component.

The superimposing lens 94 condenses partial light fluxes from the polarization conversion element 92 and superimposes the partial light fluxes in the vicinity of the image forming regions of the liquid crystal panels 400R, 400G, and 400B. The first lens array 70, the second lens array 80, and the superimposing lens 94 constitute an integrator optical system. The integrator optical system homogenizes an in-plane light intensity distribution of the white light WL emitted from the visible light source device 20 in the image forming regions of the liquid crystal panels 400R, 400G, and 400B.

### Invisible Light Source Device

The invisible light source device 150 includes a substrate 150b, a plurality of light emitting diode light sources 150a mounted on the substrate 150b, and a condensing lens (homogenizing optical element) 153.

The light emitting diode light source 150a is a light emitting diode (LED) that emits the infrared light I. The plurality of light emitting diode light sources 150a are arranged in a plane orthogonal to an optical axis of the infrared light I. The invisible light source device 150 may include only the single light emitting diode light source 150a. In this case, the light emitting diode light source 150a is disposed on the optical axis of the infrared light I.

In the embodiment, a wavelength of the infrared light I emitted by the light emitting diode light source 150a is 930 nm or more and 950 nm or less. In this case, the projector 15 projects the projection image Px of the infrared light I having a wavelength of 930 nm or more and 950 nm or less on the screen SCR. In light in the near-infrared region contained in sunlight, energy of light having a wavelength of about 940 nm is low. In other words, in sunlight, a light amount of the infrared light I having a wavelength of about 940 nm is smaller than that of light having other wavelengths. According to the embodiment, by using light having a wavelength of 930 nm or more and 950 nm or less that is around 940 nm as the infrared light I, it is possible to prevent a decrease in contrast of a pattern F of the infrared light I due to the influence of sunlight when the screen SCR is irradiated with the infrared light I. As a result, it is possible to prevent a decrease in accuracy of position detection using the pattern F of the infrared light I.

In the embodiment, the wavelength of the infrared light I emitted by the light emitting diode light source 150a may be 840 nm or more and 860 nm or less. In this case, the projector 15 projects the projection image Px of the infrared light I having a wavelength of 840 nm or more and 860 nm or less on the screen SCR. In general, a wavelength of light that can be recognized by a person is 360 nm or more and 830 nm or less. Therefore, by using the infrared light I having a wavelength of 840 nm or more and 860 nm or less as the invisible light, the infrared light I is not recognized by a viewer. A light source using a light emitting diode or laser can emit light close to visible light with high efficiency. According to the embodiment, by using light having a wavelength of 840 nm or more and 860 nm or less as the infrared light I, energy efficiency of the invisible light source device 150 can be increased, and power consumption of the projector 15 can be reduced. Further, since a light source that emits the infrared light I having a wavelength of 840 nm or more and 860 nm or less is widely used as a light source of invisible light, it is possible to stably procure parts at low cost, and it is possible to reduce manufacturing costs of the projector 15.

The condensing lens 153 is disposed on a light emission side of the light emitting diode light source 150a. For example, one convex meniscus lens or a plurality of convex meniscus lenses can be used as the condensing lens 153. The convex meniscus lens is preferably an aspherical lens formed of glass or resin in order to improve light condensing performance. The condensing lens 153 transmits the infrared light I emitted from the light emitting diode light source 150a and homogenizes an in-plane light amount of the infrared light I.

In the embodiment, a case where the condensing lens 153 is adopted as a homogenizing optical element is described. However, a configuration of the homogenizing optical element is not limited to the embodiment. For example, a diffractive optical element (DOE) such as a holographic optical element (HOE) may be adopted as the homogenizing optical element. In this case, a surface pattern for forming a homogenizing irradiation pattern is formed on the diffractive optical element serving as the homogenizing optical element, and the diffractive optical element diffracts the infrared light I transmitted through the diffractive optical element to homogenize the in-plane light amount of the infrared light I. When the diffractive optical element is adopted as the homogenizing optical element, a laser light source is used as a light source that emits the infrared light I.

### Color Separation Optical System

The color separation optical system 200 includes dichroic mirrors 210 and 220 and reflection mirrors 230, 240, and 250. The color separation optical system 200 separates the white light WL emitted from the visible light source device 20 into red light R, green light G, and blue light B, which are visible light, and guides the red light R, the green light G, and the blue light B to the liquid crystal panels 400R, 400G, and 400B, respectively. Further, the infrared light I is introduced into the color separation optical system 200 according to the embodiment and is combined with the green light G. Therefore, a part of the color separation optical system 200 according to the embodiment also functions as a combining light optical system that combines visible light and invisible light.

In the following description, when the plurality of dichroic mirrors 210 and 220 are distinguished from each other, they are referred to as the first dichroic mirror 210 and the second dichroic mirror 220. Similarly, when the plurality of reflection mirrors 230 and 240, 250 are distinguished from one another, they are referred to as the first reflection mirror 230, the second reflection mirror 240, and the third reflection mirror 250.

The first dichroic mirror (optical element, second light combining element) 210 is disposed on the optical axis AX20 of the visible light source device 20 in a manner of facing the visible light source device 20. The first dichroic mirror 210 is disposed on an optical axis AX150 of the invisible light source device 150 in a manner of facing the invisible light source device 150. In the embodiment, the optical axis AX20 of the visible light source device 20 and the optical axis AX150 of the invisible light source device 150 are orthogonal to each other. The first dichroic mirror 210 is provided in a posture inclined by 45° relative to both the optical axis AX20 of the visible light source device 20 and the optical axis AX150 of the invisible light source device 150. The first dichroic mirror 210 has a first surface 210a and a second surface 210b. The first surface 210a faces the invisible light source device 150. The second surface 210b faces the visible light source device 20.

The white light WL emitted from the visible light source device 20 is incident on the second surface 210b of the first dichroic mirror 210. The first dichroic mirror 210 reflects the red light R in the incident white light WL and transmits the green light G and the blue light B. The first dichroic mirror 210 reflects the red light R and transmits the green light G and the blue light B among the visible light contained in the white light WL. Accordingly, the first dichroic mirror 210 emits the red light R from the second surface 210b, and emits the green light G and the blue light B from the first surface 210a. The first dichroic mirror 210 separates the white light WL into the red light R, the green light G, and the blue light B.

The infrared light I emitted from the invisible light source device 150 is incident on the first surface 210a of the first dichroic mirror 210. The first dichroic mirror 210 reflects the incident infrared light I. Therefore, the first dichroic mirror 210 emits the infrared light I from the first surface 210a. The first dichroic mirror 210 combines the infrared light I, the green light G, and the blue light B on the first surface 210a.

The second dichroic mirror (optical element, light separation element) 220 is disposed on an extension line of the optical axis AX20 of the visible light source device 20. The infrared light I, the green light G, and the blue light B emitted from the first surface 210a of the first dichroic mirror 210 are incident on the second dichroic mirror 220. The second dichroic mirror 220 reflects the infrared light I and the green light G in the combined light of the incident infrared light I, green light G, and blue light B, and transmits the blue light B. Accordingly, the second dichroic mirror 220 separates the infrared light I and the green light G from the blue light B.

The first reflection mirror 230 and the second reflection mirror 240 are disposed on an optical path of the blue light B. The first reflection mirror 230 and the second reflection mirror 240 reflect substantially all of the incident blue light B. The third reflection mirror 250 is disposed on an optical path of the red light R. The third reflection mirror 250 reflects substantially all of the incident red light R.

The red light R reflected by the first dichroic mirror 210 is reflected by the third reflection mirror 250 and is guided to the second liquid crystal panel 400R. The green light G transmitted through the first dichroic mirror 210 and reflected by the second dichroic mirror 220 is guided to the first liquid crystal panel 400G. The blue light B transmitted through the first dichroic mirror 210 and the second dichroic mirror 220 is reflected by the first reflection mirror 230 and the second reflection mirror 240 and is guided to the third liquid crystal panel 400B. The infrared light I reflected by the first dichroic mirror 210 and the second dichroic mirror 220 is guided to the first liquid crystal panel 400G together with the green light G.

In the embodiment, the green light G and the infrared light I are combined with each other and are incident on the first liquid crystal panel 400G. Here, combined light of the green light G and the infrared light I is referred to as first combined light C1. The green light G and the infrared light I are combined by the first dichroic mirror 210. Therefore, the first dichroic mirror 210 functions as a light combining element that combines the green light G and the infrared light I and emits light containing the first combined light C1. The first combined light C1 is separated from the blue light B by the second dichroic mirror 220. Therefore, the second dichroic mirror 220 functions as a light separation element that separates the blue light B from the visible light and emits the first combined light C1 not containing the blue light B.

### Field Lens

The field lenses 300R, 300G, and 300B are disposed between the color separation optical system 200 and the respective liquid crystal panels 400R, 400G, and 400B on the respective optical paths of the red light R, the green light G, and the blue light B. The red light R is transmitted through the field lens 300R and is incident on an image forming region of the second liquid crystal panel 400R. The green light G reflected by the second dichroic mirror 220 is transmitted through the field lens 300G and is incident on an image forming region of the first liquid crystal panel 400G. The blue light B reflected by the third reflection mirror 250 is transmitted through the field lens 300B and is incident on an image forming region of the third liquid crystal panel 400B.

### Light Transmitting Member

The light transmitting member 505 is disposed on a light incident surface side of the first liquid crystal panel 400G. The light transmitting member 505 according to the embodiment is disposed between the first incident-side polarizing plate 410G and the first liquid crystal panel 400G. The light transmitting member 505 may be disposed on an optical path of the first combined light C1 and between the first incident-side polarizing plate 410G and the first emission-side polarizing plate 420G.

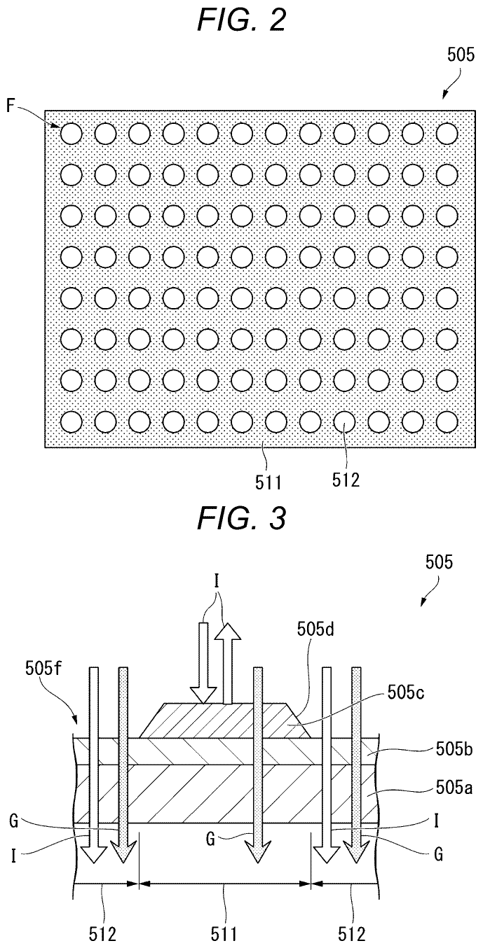

FIG. 2 is a schematic plan view showing the light transmitting member 505 according to the embodiment. The light transmitting member 505 includes a shielding portion 511 and transmission portions 512. The shielding portion 511 shields the infrared light I by reflecting or absorbing the infrared light I, and transmits visible light (particularly, the green light G in the embodiment). On the other hand, the transmission portions 512 transmit both the infrared light I and the visible light. In the embodiment, the transmission portions 512 are arranged in a predetermined pattern F. In the embodiment, the predetermined pattern F of the transmission portions 512 is a dot-shaped pattern. Therefore, the infrared light I that passed through the light transmitting member 505 includes a predetermined dot-shaped pattern F. On the other hand, the visible light that passed through the light transmitting member 505 is not shielded by the light transmitting member 505, and the pattern F does not change before and after the visible light passes through the light transmitting member 505.

FIG. 3 is a schematic cross-sectional view showing the light transmitting member 505 according to the embodiment.

The light transmitting member 505 according to the embodiment has a plate shape and has an incident surface 505f on which the green light G and the infrared light I are incident. The light transmitting member 505 according to the embodiment includes a base material 505a, an antireflection film 505b, and a shielding film 505c.

The base material 505a is made of, for example, quartz glass. The base material 505a transmits both visible light and infrared light. The antireflection film 505b is formed on the entire surface of the base material 505a on a side close to the incident surface 505f. The antireflection film 505b prevents light incident from a surface from being reflected.

The shielding film 505c is formed on a part of the antireflection film 505b on the base material 505a on a side close to the incident surface 505f. The shielding film 505c according to the embodiment is an infrared light reflecting film. Therefore, the shielding film 505c reflects the infrared light I and transmits visible light (particularly, the green light G in the embodiment). The shielding film 505c may shield the infrared light I by absorbing the infrared light I. That is, the shielding film 505c may be any film that shields the infrared light I and transmits the visible light.

In the light transmitting member 505 according to the embodiment, a region where the shielding film 505c is formed functions as the shielding portion 511, and the other regions function as the transmission portions 512. Therefore, in the light transmitting member 505 according to the embodiment, the region where the shielding film 505c is not formed forms the predetermined dot-shaped pattern F.

In a method for manufacturing the light transmitting member 505, first, the antireflection film 505b is vapor-deposited on a surface of the base material 505a on the side close to the incident surface 505f. Next, the shielding film 505c is formed by a metal mask method. In the metal mask method, the shielding film 505c is vapor-deposited on the surface of the antireflection film 505b through a metal mask in which holes corresponding to the predetermined pattern F are formed. When the metal mask method is adopted as a method for forming the shielding film 505c, the shielding film 505c may be vapor-deposited only on a portion other than the predetermined pattern F. The metal mask method is advantageous in that accuracy of a metal mask is easily increased and productivity of the metal mask is high.

The shielding film 505c may be formed by a lift-off method. In the lift-off method, first, a resist is applied to the surface of the antireflection film 505b, exposure and development are performed using a photomask in accordance with the predetermined pattern F, and the shielding film 505c is vapor-deposited on the remaining resist. Finally, only the shielding film 505c formed directly on the antireflection film 505b remains by removing the remaining resist.

### Liquid Crystal Panel

The liquid crystal panels 400R, 400G, and 400B respectively modulate the incident red light R, green light G, and blue light B according to image information to form an image. An operation mode of the liquid crystal panel may be any one of a TN mode, a VA mode, a lateral electric field mode, and the like, and is not limited to a specific mode.

The first combined light C1 (that is, the green light G and the infrared light I) is incident on the first liquid crystal panel 400G. The first liquid crystal panel 400G modulates the first combined light C1. The first liquid crystal panel 400G modulates at least the green light G contained in the first combined light C1. The red light R is incident on the second liquid crystal panel 400R. The second liquid crystal panel 400R modulates the red light R. The blue light B is incident on the third liquid crystal panel 400B. The third liquid crystal panel 400B modulates the blue light B. In the embodiment, the liquid crystal panels 400R, 400G, and 400B modulate P-polarized light into S-polarized light in an OFF region. On the other hand, P-polarized light is transmitted (as P-polarized light) in an ON region.

### Polarizing Plate

The first incident-side polarizing plate 410G is disposed on a light incident surface side of the first liquid crystal panel 400G. The first incident-side polarizing plate 410G may be disposed on an optical path of the first combined light C1 and between the second dichroic mirror 220 and the first liquid crystal panel 400G. The first incident-side polarizing plate 410G transmits the first combined light C1 on the light incident side of the first liquid crystal panel 400G. The first incident-side polarizing plate 410G P-polarizes the green light G that was P-polarized by the polarization conversion element 92 and then has polarization disturbed on the optical path. That is, the first incident-side polarizing plate 410G transmits the P-polarized green light G and restricts transmission of the S-polarized green light G. A polarizing state of the infrared light I transmitted through the first incident-side polarizing plate 410G will be described in detail later.

The first emission-side polarizing plate 420G is disposed on a light emitting surface side of the first liquid crystal panel 400G. The first emission-side polarizing plate 420G may be disposed on the optical path of the first combined light C1 and between the first liquid crystal panel 400G and the cross dichroic prism 500. The first emission-side polarizing plate 420G transmits the first combined light C1 on the light emission side of the first liquid crystal panel 400G. The first emission-side polarizing plate 420G transmits the S-polarized green light G and restricts transmission of the P-polarized green light G.

The second incident-side polarizing plate 410R is disposed on a light incident surface side of the second liquid crystal panel 400R. The second incident-side polarizing plate 410R may be disposed on an optical path of the red light R and between the first dichroic mirror 210 and the second liquid crystal panel 400R. The second incident-side polarizing plate 410R transmits the red light R on the light incident side of the second liquid crystal panel 400R. The second incident-side polarizing plate 410R P-polarizes the red light R that was P-polarized by the polarization conversion element 92 and then has polarization disturbed on the optical path. That is, the second incident-side polarizing plate 410R transmits the P-polarized red light R and restricts transmission of the S-polarized red light R.

The second emission-side polarizing plate 420R is disposed on a light emitting surface side of the second liquid crystal panel 400R. The second emission-side polarizing plate 420R may be disposed on the optical path of the red light R and between the second liquid crystal panel 400R and the cross dichroic prism 500. The second emission-side polarizing plate 420R transmits the red light R on the light emission side of the second liquid crystal panel 400R. The second emission-side polarizing plate 420R transmits the S-polarized red light R and restricts transmission of the P-polarized red light R.

The third incident-side polarizing plate 410B is disposed on a light incident surface side of the third liquid crystal panel 400B. The third incident-side polarizing plate 410B may be disposed on the optical path of the blue light B and between the first dichroic mirror 210 and the third liquid crystal panel 400B. The third incident-side polarizing plate 410B transmits the blue light B on the light incident side of the third liquid crystal panel 400B. The third incident-side polarizing plate 410B P-polarizes the blue light B that was P-polarized by the polarization conversion element 92 and then has polarization disturbed on the optical path. That is, the third incident-side polarizing plate 410B transmits the P-polarized blue light B and restricts transmission of the S-polarized blue light B.

The third emission-side polarizing plate 420B is disposed on a light emitting surface side of the third liquid crystal panel 400B. The third emission-side polarizing plate 420B may be disposed on the optical path of the blue light B and between the third liquid crystal panel 400B and the cross dichroic prism 500. The third emission-side polarizing plate 420B transmits the blue light B on the light emission side of the third liquid crystal panel 400B. The third emission-side polarizing plate 420B transmits the S-polarized blue light B and restricts transmission of the P-polarized blue light B.

In the embodiment, the first incident-side polarizing plate 410G is an organic polarizing plate. On the other hand, polarizing plates (the first emission-side polarizing plate 420G, the second incident-side polarizing plate 410R, the second emission-side polarizing plate 420R, the third incident-side polarizing plate 410B, and the third emission-side polarizing plate 420B) other than the first incident-side polarizing plate 410G are inorganic polarizing plates such as wire grid polarizing plates.

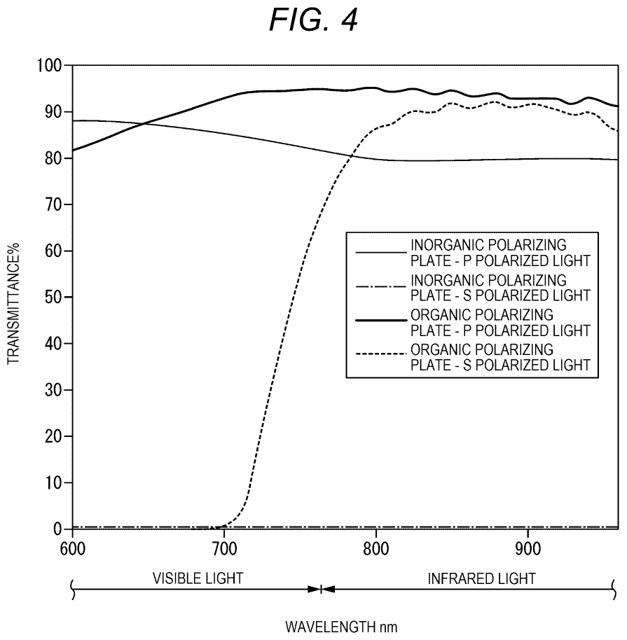

FIG. 4 is a graph showing a relation between a wavelength and a transmittance of incident light by an inorganic polarizing plate that is used as the first incident-side polarizing plate 410G and an inorganic polarizing plate that is used as other polarizing plates.

As shown in FIG. 4, the inorganic polarizing plate has a high transmittance for P-polarized light and a low transmittance for S-polarized light regardless of a wavelength of incident light. Therefore, the inorganic polarizing plate transmits the P-polarized light and restricts transmission of the S-polarized light for visible light and infrared light.

On the other hand, the organic polarizing plate has a high transmittance for P-polarized light and a low transmittance for S-polarized light in a region where a wavelength of light is visible light. The organic polarizing plate has a high transmittance for both the P-polarized light and the S-polarized light in an infrared light region. Therefore, the organic polarizing plate transmits the P-polarized light and restricts transmission of the S-polarized light for visible light in a similar manner to the inorganic polarizing plate. On the other hand, the organic polarizing plate transmits both the P-polarized light and the S-polarized light with a high transmittance for the infrared light.

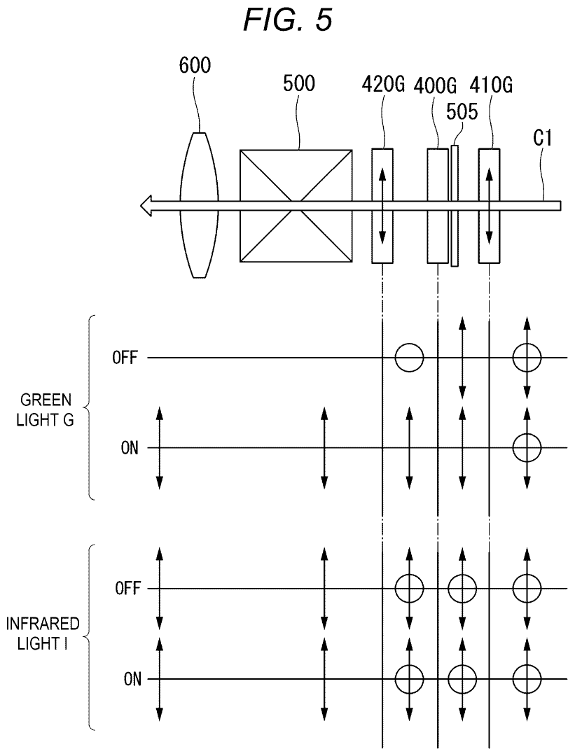

FIG. 5 is a conceptual diagram showing a polarizing state of the first combined light C1 before and after the first liquid crystal panel 400G. Polarizing states of the green light G and the infrared light I are represented by arrows and circles. Arrows represent P-polarized light, and circles represent S-polarized light. A region where an arrow and a circle overlap refers to a state in which both the P-polarized light and the S-polarized light are contained.

As shown in FIG. 5, the first combined light C1 is transmitted through the first incident-side polarizing plate 410G, the light transmitting member 505, the first liquid crystal panel 400G, and the first emission-side polarizing plate 420G in this order (from a right side to a left side in FIG. 5). When the green light G contained in the first combined light C1 passes through the first incident-side polarizing plate 410G, the S-polarized light is shielded and only the P-polarized light is transmitted. The P-polarized light of the green light G emitted from the first incident-side polarizing plate 410G passes through the light transmitting member 505 and is incident on the first liquid crystal panel 400G. The first liquid crystal panel 400G modulates the P-polarized green light G into S-polarized light in an OFF region, and transmits the P-polarized green light G in an ON region. When the green light G emitted from the first liquid crystal panel 400G passes through the first emission-side polarizing plate 420G, the S-polarized light is shielded and only the P-polarized light is transmitted. Accordingly, only light transmitted through the ON region of the first liquid crystal panel 400G is incident on the cross dichroic prism 500 as image light.

On the other hand, when the infrared light I contained in the first combined light C1 passes through the first incident-side polarizing plate 410G, both the P-polarized light and the S-polarized light are transmitted. That is, the infrared light I maintains a non-polarizing state when the infrared light I passes through the first incident-side polarizing plate 410G. This is because an organic polarizing plate having a high transmittance for both the P-polarized light and the S-polarized light of the infrared light I is adopted as the first incident-side polarizing plate 410G. When the infrared light I emitted from the first incident-side polarizing plate 410G is transmitted through the light transmitting member 505, a part of the light is shielded by the shielding portion 511 of the light transmitting member 505 to form the pattern F, and then is incident on the first liquid crystal panel 400G.

In the infrared light I incident on the ON region of the first liquid crystal panel 400G, the P-polarized light and the S-polarized light are transmitted. In the infrared light I incident on the OFF region of the first liquid crystal panel 400G, the P-polarized light and the S-polarized light are inverted and then transmitted. More specifically, the first liquid crystal panel 400G modulates the P-polarized infrared light I into S-polarized light and modulates the S-polarized infrared light I into P-polarized light in the OFF region. That is, the infrared light I is reversed between the P-polarized light and the S-polarized light before and after passing through the first liquid crystal panel 400G. In the embodiment, since the infrared light I incident on the first liquid crystal panel 400G is in a non-polarizing state, the non-polarizing state is maintained even when the P-polarized light and the S-polarized light are reversed from each other, and the P-polarized light and the S-polarized light are transmitted without changing in appearance. That is, in the infrared light I incident on the first liquid crystal panel 400G, the P-polarized light and the S-polarized light are transmitted in both the ON region and the OFF region and are incident on the first emission-side polarizing plate 420G.

Since the S-polarized light of the infrared light I transmitted through the first emission-side polarizing plate 420G is shielded and only the P-polarized light is transmitted, a light amount on an irradiation surface is uniformly reduced to approximately half. Accordingly, the infrared light I that passed through either the ON region or the OFF region of the first liquid crystal panel 400G can also be incident on the cross dichroic prism 500. Therefore, the pattern F of the infrared light I formed in the light transmitting member 505 is not affected by the first liquid crystal panel 400G, and the infrared light I that forms the pattern F can be directly incident on the cross dichroic prism 500.

In the embodiment, a case where an organic polarizing plate is adopted as the first incident-side polarizing plate 410G and an inorganic polarizing plate is adopted as the first emission-side polarizing plate 420G is described. Alternatively, an inorganic polarizing plate may be adopted as the first incident-side polarizing plate 410G, and an organic polarizing plate may be adopted as the first emission-side polarizing plate 420G. In this case, similar to the green light G, when the infrared light I passes through the first incident-side polarizing plate 410G, the S-polarized light is shielded and only the P-polarized light is transmitted. Further, the P-polarized light of the infrared light I emitted from the first incident-side polarizing plate 410G is incident on the first liquid crystal panel 400G. The first liquid crystal panel 400G modulates the P-polarized infrared light I into S-polarized light in the OFF region, and transmits the P-polarized infrared light I in the ON region. When the infrared light I emitted from the first liquid crystal panel 400G passes through the first emission-side polarizing plate 420G, the first emission-side polarizing plate 420G transmits the infrared light I in which the S-polarized light and the P-polarized light passed through any region.

As described above, at least one of the first incident-side polarizing plate 410G and the first emission-side polarizing plate 420G needs to polarize and transmit the green light G and transmit the infrared light I without polarizing the infrared light I. That is, at least one of the first incident-side polarizing plate 410G and the first emission-side polarizing plate 420G may be an organic polarizing plate. However, when an inorganic polarizing plate is adopted as the first incident-side polarizing plate 410G, there is a risk that spots may appear in an image of the infrared light I due to a difference between transmittance of the P-polarized light and transmittance of the S-polarized light in the first emission-side polarizing plate 420G. Therefore, as described in the embodiment described above, it is more preferable that the first incident-side polarizing plate 410G is an organic polarizing plate, polarizes and transmits the green light G, and transmits the infrared light I without polarizing the infrared light I.

Further, although a case is described in the embodiment in which an organic polarizing plate is adopted only for the first incident-side polarizing plate 410G among a plurality of polarizing plates used in the projector 15, the organic polarizing plate can also be adopted for the other polarizing plates. That is, among the plurality of polarizing plates, at least the first incident-side polarizing plate 410G needs to polarize and transmit the visible light and transmit the infrared light I without polarizing the infrared light I. Since the organic polarizing plate absorbs a part of transmitted light and generates heat, the organic polarizing plate may be carbonized unless precise temperature control is performed. As shown in the embodiment, by using an inorganic polarizing plate as the other polarizing plates (the first emission-side polarizing plate 420G, the second incident-side polarizing plate 410R, the second emission-side polarizing plate 420R, the third incident-side polarizing plate 410B, and the third emission-side polarizing plate 420B) other than the first incident-side polarizing plate 410G, precise temperature control for the other polarizing plates is unnecessary, and costs of the projector 15 can be reduced.

### Cross Dichroic Prism

As shown in FIG. 1, the cross dichroic prism 500 combines image light emitted from the liquid crystal panels 400R, 400G, and 400B to form a color image. The cross dichroic prism 500 according to the embodiment combines the first combined light C1 emitted from the first liquid crystal panel 400G, the red light R emitted from the second liquid crystal panel 400R, and the blue light B emitted from the third liquid crystal panel 400B into second combined light C2. The second combined light C2 combined by the cross dichroic prism 500 includes the infrared light I in addition to the red light R, the green light G, and the blue light B.

The cross dichroic prism 500 is formed in a substantially cubic shape as a whole, and is disposed such that apex angles of four right angle prisms overlap with a common center position in a side view. In the cross dichroic prism 500, a dielectric multilayer film (not shown) is formed at an interface where the right angle prisms are bonded to one another. The interface described above is formed in a substantially X shape in a side view.

### Projection Optical System

The projection optical system 600 faces the screen SCR. The projection optical system 600 enlarges and projects an image formed by the second combined light emitted from the cross dichroic prism 500 to form the projection images P and Px on the screen SCR. Although not shown, the projection optical system 600 includes a plurality of lenses.

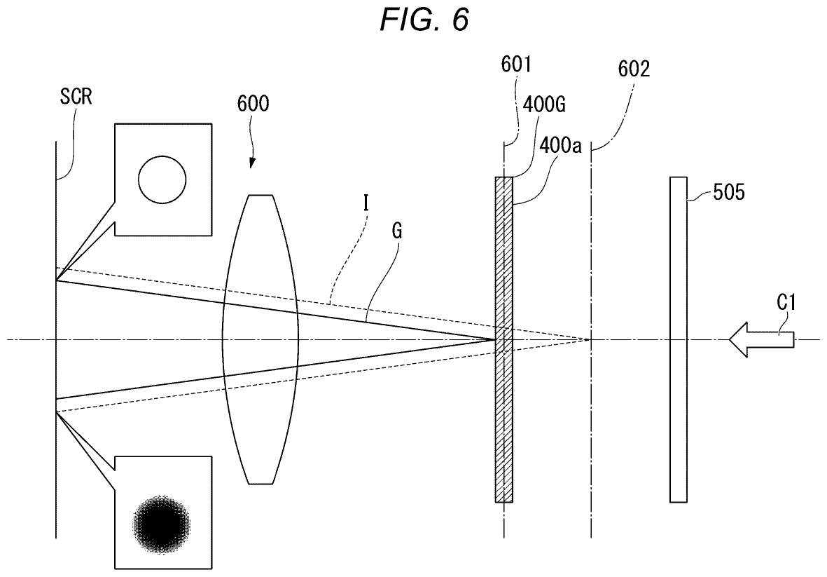

FIG. 6 is a schematic view showing a positional relation among the projection optical system 600, the first liquid crystal panel 400G, and the light transmitting member 505. In FIG. 6, the cross dichroic prism 500 and the first emission-side polarizing plate 420G disposed between the projection optical system 600 and the first liquid crystal panel 400G are not shown.

The projection optical system 600 forms image forming surfaces 601 and 602 on a side opposite to a projection direction. In the following description, an image forming surface of the projection optical system 600 by the green light G is referred to as a green light image forming surface 601, and an image forming surface of the projection optical system 600 by the infrared light I is referred to as an infrared light image forming surface 602.

Optical path lengths from the projection optical system 600 to the image forming surfaces 601 and 602 differ for each wavelength due to an influence of chromatic aberration of the projection optical system 600. Therefore, the green light image forming surface 601 and the infrared light image forming surface 602 are disposed in a manner of deviating from each other on an optical path of the first combined light C1.

The green light image forming surface 601 overlaps the first liquid crystal panel 400G. More specifically, the image forming surface 601 overlaps a liquid crystal panel body 400a of the first liquid crystal panel 400G. Accordingly, an image of the green light G formed by the first liquid crystal panel 400G is clearly projected on the screen SCR through the projection optical system 600.

On the other hand, the infrared light image forming surface 602 is deviated from the light transmitting member 505 in an axial direction of the optical path of the first combined light C1. The infrared light image forming surface 602 according to the embodiment is deviated from the light transmitting member 505 to a side where the first liquid crystal panel 400G is disposed.

Since the infrared light image forming surface 602 is deviated from the light transmitting member 505, an image of the pattern F of the infrared light I formed by being transmitted through the light transmitting member 505 is not focused on the screen SCR. Therefore, when the dot-shaped pattern F is formed by the light transmitting member 505, an image projected on the screen SCR shape by the projection optical system 600 is an image having an illuminance distribution close to a Gaussian distribution in which illuminance gradually decreases from a dot center toward the outside.

As shown in FIG. 1, the pattern F of the infrared light I projected on the screen SCR is imaged by the imaging device 710 and is used for image alignment in the control unit 730. Here, the pattern F of the infrared light I imaged by the imaging device 710 preferably has a Gaussian distribution on the screen SCR. In this case, a position of image light can be recognized with high accuracy by detecting the centroid of the dot-shaped pattern F. In the embodiment, since the projector 15 forms the pattern F of the infrared light I having an illuminance distribution close to the Gaussian distribution on the screen SCR, the imaging device 710 can identify the pattern F of the infrared light I with high accuracy, and highly accurate alignment can be performed.

As shown in FIG. 6, the light transmitting member 505 according to the embodiment is deviated from the infrared light image forming surface 602 to a side opposite to the first liquid crystal panel 400G in an axial direction of an optical axis. Accordingly, the first liquid crystal panel 400G is not disposed between the light transmitting member 505 and the image forming surface 602. According to the embodiment, it is possible to design a distance between the light transmitting member 505 and the infrared light image forming surface 602 without worrying about interference with the first liquid crystal panel 400G, and it is possible to form an image of the infrared light I having a more preferable illuminance distribution on the screen SCR.

Although not shown in FIG. 6, the projection optical system 600 forms image forming surfaces of the red light R and the blue light B on respective optical paths of the red light R and the blue light B. The image forming surface of the red light R overlaps the liquid crystal panel body 400a of the second liquid crystal panel 400R. Similarly, the image forming surface of the blue light B overlaps the liquid crystal panel body 400a of the third liquid crystal panel 400B. Accordingly, the projection image P formed by the first liquid crystal panel 400G, the second liquid crystal panel 400R, and the third liquid crystal panel 400B is clearly projected onto the screen SCR through the projection optical system 600.

### Movement Mechanism

The movement mechanism 720 is connected to the control unit 730. The movement mechanism 720 receives an electric signal from the control unit 730 and moves the projection optical system 600. Accordingly, the control unit 730 changes a position of a projection image on the screen SCR.

### Control Unit

The control unit 730 is implemented by, for example, a computer or an integrated circuit in which processing of the imaging device 710, the movement mechanism 720, the invisible light source device 150, and drive devices that respectively drive the liquid crystal panels 400R, 400G, and 400B are incorporated as programs. The control unit 730 is, for example, a processor. The control unit 730 is connected to the imaging device 710, the movement mechanism 720, and the liquid crystal panels 400R, 400G, and 400B in a wired or wireless manner (not shown).

An image on the screen SCR may change over time due to an influence of heat generated in the projection optical system 600, the cross dichroic prism 500, and the liquid crystal panels 400R, 400G, and 400B. The control unit 730 estimates positional deviation of an image of the visible light on the screen SCR based on an imaging result of the pattern F of the infrared light I on the screen SCR. Further, the control unit 730 performs control for correcting the positional deviation between images of the infrared light and the visible light on the screen SCR based on an estimation result.

In the embodiment, the control unit 730 can control the movement mechanism 720 based on an image imaged by the imaging device 710. The control unit 730 operates the movement mechanism 720 based on an estimation result of a position of the projection image P of the visible light, and moves the projection optical system 600 in a direction of correcting positional deviation of an image of the visible light.

Further, the control unit 730 may change a region of an image formed in an image display region of each of the liquid crystal panels 400R, 400G, and 400B based on an image imaged by the imaging device 710. In this case, based on the estimation result of the position of the image of the visible light, the control unit 730 causes the liquid crystal panels 400R, 400G, and 400B to form images in which the positional deviation of the image of the visible light is corrected, and corrects the positional deviation of the image on the screen SCR.

### Summary of Embodiment

The projector 15 according to the embodiment described above includes the light source device unit 2, the first dichroic mirror 210 and the second dichroic mirror 220 serving as an optical element, the first liquid crystal panel 400G, the first incident-side polarizing plate 410G, the first emission-side polarizing plate 420G, and the projection optical system 600. The light source device unit 2 emits visible light including the green light G serving as first light having a first wavelength and the infrared light I serving as invisible light. The first dichroic mirror 210 and the second dichroic mirror 220 emit the first combined light C1 containing the green light G and the infrared light I. The first liquid crystal panel 400G modulates the first combined light C1. The first incident-side polarizing plate 410G transmits the green light G on the light incident side of the first liquid crystal panel 400G. The first emission-side polarizing plate 420G transmits the green light G on the light emission side of the first liquid crystal panel 400G. The projection optical system 600 projects the first combined light C1 emitted from the first liquid crystal panel 400G. The first dichroic mirror 210 serving as an optical element functions as at least one of a light separation element and a light combining element. Here, the light separation element is a light separation element that separates, from the visible light, light having a wavelength different from a wavelength (first wavelength) of the green light G. On the other hand, the light combining element is an optical element that combines the green light G and the infrared light I. The first dichroic mirror 210 functions as a light combining element that combines the green light G and the infrared light I, and the second dichroic mirror 220 functions as a light separation element that separates the blue light B from combined light of the green light G and the blue light B. The infrared light I is reflected by the first dichroic mirror 210 and the second dichroic mirror 220.

The projector 15 according to the embodiment includes the light source device unit 2 that emits the infrared light I which is invisible light, in addition to the visible light for forming a projection image. In the projector 15 according to the embodiment, an optical path of the infrared light I emitted from the light source device unit 2 overlaps an optical path of the green light G which is visible light. In the projector 15 according to the embodiment, the green light G and the infrared light I whose optical paths overlap each other pass through the common first liquid crystal panel 400G as the first combined light C1 and are projected from the projection optical system 600. Therefore, in the projector 15 according to the embodiment, it is possible to directly track movement or deviation of the projection image P due to a factor on the optical path of the visible light (the green light G) by using the invisible light (the infrared light I). In the projector 15 according to the embodiment, a movement amount of the projection image P formed by the green light G coincides with a movement amount detected from the projection image Px formed by the infrared light I, and adjustment of the projection image can be accurately performed based on the movement amounts. In this case, in order to prevent the infrared light I from being affected by modulation of the first liquid crystal panel 400G, the infrared light I incident on the first liquid crystal panel 400G needs to be in a non-polarizing state. When the infrared light I in a non-polarizing state is transmitted through an optical element such as a dichroic mirror, polarization may be disturbed, and the non-polarizing state may not be maintained. Therefore, in the projector 15 according to the embodiment, the optical elements 210 and 220 reflect the infrared light I to thereby emit the first combined light C1. Therefore, the infrared light I is not transmitted through the optical elements 210 and 220, and the optical elements 210 and 220 can prevent disturbance of the polarization of the infrared light I. Accordingly, the infrared light I can be incident on the first liquid crystal panel 400G while maintaining the non-polarizing state, the infrared light I can be prevented from being affected by the modulation of the first liquid crystal panel 400G, and the infrared light I can be sufficiently projected forward from the projection optical system 600.

In the embodiment, the three-panel projector 15 including the liquid crystal panels 400R, 400G, and 400B that respectively modulate the red light R, the green light G, and the blue light B was described. Alternatively, the configuration described above may be adopted in a single-plate projector that projects monochromatic light onto the screen SCR. In the single-plate projector, the white light WL is used as the first light. Therefore, the first wavelength of the first light in this case is a wavelength of the visible light (360 nm or more and 830 nm or less).

An arrangement of an optical element that combines the infrared light I and the green light G is not limited to the embodiment. A dichroic mirror serving as an optical element that combines the infrared light I and the green light G may be disposed on an optical path of the green light G. For example, in the above-described color separation optical system 200, a dichroic mirror (light combining element) on which the infrared light I is incident may be separately disposed between the first dichroic mirror 210 and the second dichroic mirror 220 (a point P1 in FIG. 1) or between the second dichroic mirror 220 and the field lens 300G (a point P2 in FIG. 1).

In the projector 15 according to the embodiment, the first incident-side polarizing plate 410G is disposed on the optical path of the first combined light C1. The first incident-side polarizing plate 410G polarizes and transmits the green light G serving as the first light, and transmits the infrared light I serving as the invisible light without polarizing the infrared light I. According to this configuration, the first incident-side polarizing plate 410G disposed on the optical path of the first combined light C1 transmits the infrared light I which is invisible light without polarizing the infrared light I. Therefore, the infrared light I can be prevented from being affected by the modulation of the first liquid crystal panel 400G, and the infrared light I can be sufficiently projected forward from the projection optical system 600. According to this configuration, the first incident-side polarizing plate 410G can be disposed on the optical path of the first combined light C1, and optical paths of the green light G and the infrared light I can be simplified. Accordingly, the number of components constituting the projector 15 can be easily reduced, and the projector 15 can be manufactured at low cost.

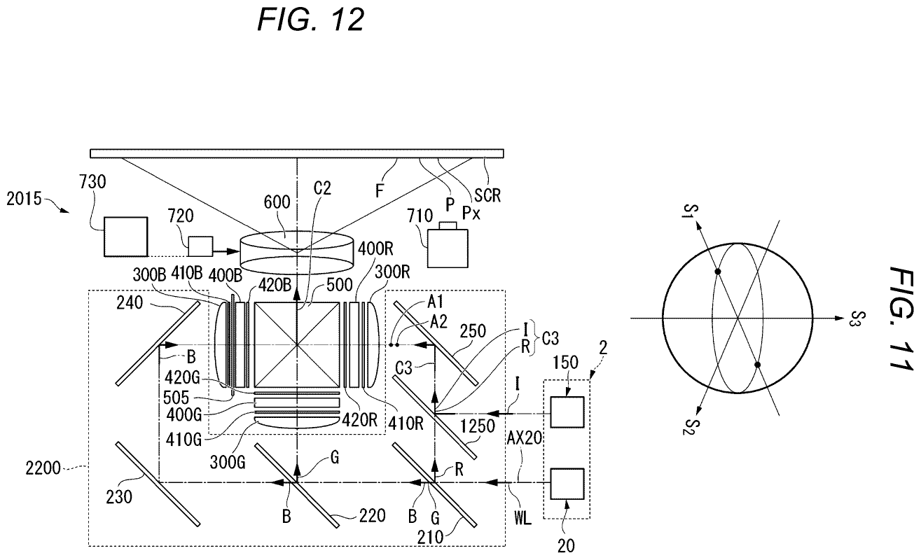

An arrangement of the first incident-side polarizing plate 410G that transmits the green light G is not limited to the embodiment. For example, when an optical element that combines the infrared light I and the green light G is disposed between the second dichroic mirror 220 and the field lens 300G (the point P2 in FIG. 1) as described above, the first incident-side polarizing plate 410G may be disposed between the second dichroic mirror 220 and the point P2 (a point P3 in FIG. 12). In this case, since the green light G before being combined with the infrared light I is incident on the first incident-side polarizing plate 410G, an inorganic polarizing plate can be adopted as the first incident-side polarizing plate 410G.

The projector 15 according to the embodiment includes the color separation optical system 200, the second liquid crystal panel 400R, the third liquid crystal panel 400B, the second incident-side polarizing plate 410R, the second emission-side polarizing plate 420R, the third incident-side polarizing plate 410B, the third emission-side polarizing plate 420B, and the cross dichroic prism 500 serving as the first light combining element. The color separation optical system 200 separates the visible light emitted from the visible light source device 20 into the green light G serving as the first light, the red light R serving as the second light, and the blue light B serving as the third light. The second liquid crystal panel 400R modulates the red light R. The third liquid crystal panel 400B modulates the blue light B. The second incident-side polarizing plate 410R transmits the red light R on the light incident side of the second liquid crystal panel 400R. The second emission-side polarizing plate 420R transmits the red light R on the light emission side of the second liquid crystal panel 400R. The third incident-side polarizing plate 410B transmits the blue light B on the light incident side of the third liquid crystal panel 400B. The third emission-side polarizing plate 420B transmits the blue light B on the light emission side of the third liquid crystal panel 400B. The cross dichroic prism 500 combines the first combined light C1 emitted from the first liquid crystal panel 400G, the red light R emitted from the second liquid crystal panel 400R, and the blue light B emitted from the third liquid crystal panel 400B into the second combined light C2. The projection optical system 600 projects the second combined light C2 emitted from the cross dichroic prism 500. According to the projector 15 in the embodiment, it is possible to project light containing the infrared light I forward in a projector that emits image light of two or more colors. In the projector 15 that emits image light of two or more colors, deformation and movement of a projection image due to over-time deformation of components such as the projection optical system 600, the cross dichroic prism 500, and the liquid crystal panels 400R, 400G, and 400B caused by internal heat generation are likely to become significant. According to the embodiment, in the projector 15 that emits image light of three or more colors, a position of an image can be corrected by the infrared light I, and an effect of position correction can be made more significant.

In the projector 15 according to the embodiment, the first light to be combined with the infrared light I to form the first combined light C1 is the green light G. The green light G has highest visibility among light of the three primary colors. In the projector 15 according to the embodiment, the optical path of the infrared light I can be disposed overlapping the optical path of the green light G, and movement and positional deviation of a member on the optical path of the green light G can be directly tracked by the infrared light I. Therefore, it is possible to accurately correct a position of an image of the green light G having high visibility, and a viewer is less likely to feel positional deviation of the image.

In the projector 15 according to the embodiment, the light source device unit includes the visible light source device 20 that emits the visible light including the green light G serving as the first light, and the invisible light source device 150 that emits the infrared light I serving as the invisible light. The optical element described above is the first dichroic mirror 210 serving as a second light combining element that combines the green light G and the infrared light I. According to this configuration, the green light G and the infrared light I respectively emitted from the light source devices 20 and 150 can be combined by the first dichroic mirror 210 to form the first combined light C1. Since the first dichroic mirror 210 is the above-described optical element, the first dichroic mirror 210 forms the first combined light C1 when the infrared light I is reflected. Therefore, the first combined light C1 can be formed while preventing disturbance of polarization of the infrared light I.

In the projector 15 according to the embodiment, the invisible light source device 150 includes the light emitting diode light source 150a that emits the infrared light I serving as the invisible light. The light emitting diode light source 150a can emit light in a non-polarizing state. In the projector 15 according to the embodiment, the infrared light I in a non-polarizing state from the invisible light source device 150 can be incident on the first liquid crystal panel 400G. Therefore, it is possible to prevent the infrared light I from being affected by the modulation of the first liquid crystal panel 400G, and it is easy to improve recognition accuracy of the infrared light I projected on the screen SCR.

In the projector 15 according to the embodiment, the invisible light source device 150 emits the infrared light I having a wavelength of 930 nm or more and 950 nm or less. In the projector 15 according to the embodiment, since the light having the wavelength of 930 nm or more and 950 nm or less, which has low solar energy, is used as the infrared light I, it is possible to prevent a decrease in contrast of the pattern F of the infrared light I due to the influence of sunlight when the infrared light I is projected on the screen SCR. As a result, it is possible to prevent a decrease in accuracy of position detection using the pattern F of the infrared light I.

In the projector 15 according to the embodiment, the invisible light source device 150 emits the infrared light I having a wavelength of 840 nm or more and 860 nm or less. In a general light source, light closer to visible light can be emitted with higher efficiency. In the projector 15 according to the embodiment, since the light having the wavelength of 840 nm or more and 860 nm or less is used as the infrared light I, energy efficiency in the invisible light source device 150 can be increased, and low power consumption of the projector 15 can be achieved. Further, since a light source that emits the infrared light I having a wavelength of 840 nm or more and 860 nm or less is widely used as a light source of invisible light, it is possible to stably procure parts at low cost, and it is possible to reduce manufacturing costs of the projector 15.

The projector 15 according to the embodiment includes the light transmitting member 505 disposed between the first incident-side polarizing plate 410G and the first emission-side polarizing plate 420G. The light transmitting member 505 includes the shielding portion 511 and a plurality of the transmission portions 512. The shielding portion 511 shields the infrared light I serving as the invisible light and transmits the green light G serving as the first light, both of which are contained in the first combined light C1. The transmission portions 512 transmit both the infrared light I serving as the invisible light and the green light G serving as the first light, both of which are contained in the first combined light C1. The transmission portions 512 are arranged in the predetermined pattern F. The infrared light I serving as the invisible light projected by the projection optical system 600 includes the predetermined pattern F. In the projector 15 according to the embodiment, the invisible light (the infrared light I) having the predetermined pattern F is projected on the screen SCR. Therefore, it is possible to detect a movement amount of the projection image P formed by the visible light with high accuracy by detecting position information or the like of the predetermined pattern F by the imaging device 710.

In the projector 15 according to the embodiment, the light transmitting member 505 includes the base material 505a that transmits light and the shielding film 505c that is formed on one surface side of the base material 505a, shields invisible light, and transmits the green light G serving as the first light. The predetermined pattern F is formed on a region where the shielding film 505c is not formed on the one surface side of the base material 505a. In the projector 15 according to the embodiment, since the shielding film 505c that absorbs the infrared light I is fairly small relative to the entire light transmitting member 505, it is easy to prevent a temperature rise of the light transmitting member 505. Accordingly, deterioration of the pattern F due to thermal strain or the like of the light transmitting member 505 is less likely to occur, and high accuracy of position detection is easily maintained.

In the projector 15 according to the embodiment, the light source device unit 2 includes the light source 150a that emits the infrared light I serving as the invisible light and the condensing lens 153 that transmits the infrared light I serving as the invisible light emitted from the light source 150a and forms a homogenizing irradiation pattern. In the projector 15 according to the embodiment, a light amount of the infrared light I is homogenized by being transmitted through the condensing lens 153. According to the embodiment, the light source device unit 2 can emit the infrared light I with high homogenization. Accordingly, it is possible to prevent variation in an in-plane light amount caused by the light source 150a in the pattern F of the infrared light I formed by being transmitted through the light transmitting member 505. Accordingly, accuracy of position detection using the pattern F of the infrared light I can be improved. Further, since the infrared light I can be emitted with high homogenization and a simple structure by using the condensing lens 153, it is possible to reduce size and cost of the projector 15.

In the projector 15 according to the embodiment, the image forming surface 601 of the projection optical system 600 formed by the green light G serving as the first light overlaps the first liquid crystal panel 400G. The image forming surface 602 of the projection optical system 600 formed by the infrared light I serving as the invisible light is deviated from the light transmitting member 505 in the axial direction of the optical path of the first combined light C1. In the projector 15 according to the embodiment, an image of the binary pattern F of the infrared light I formed by being transmitted through the light transmitting member 505 is not focused on the screen SCR and becomes an image having an illuminance distribution close to a Gaussian distribution. Therefore, the imaging device 710 can identify the pattern F of the infrared light I with high accuracy, and the projection image P can be aligned with high accuracy.

In the projector 15 according to the embodiment, the image forming surface 602 of the projection optical system 600 formed by the infrared light I serving as the invisible light is deviated from the light transmitting member 505 toward a side where the first liquid crystal panel 400G is disposed. That is, the light transmitting member 505 is deviated to an opposite side of the first liquid crystal panel 400G relative to the infrared light image forming surface 602. In the projector 15 according to the embodiment, the first liquid crystal panel 400G is not disposed between the light transmitting member 505 and the infrared light image forming surface 602. Therefore, it is possible to design a distance between the light transmitting member 505 and the image forming surface 602 regardless of a positional relation with the first liquid crystal panel 400G, and an image of the infrared light I having a more preferable illuminance distribution can be formed on the screen SCR.

The projection system 16 according to the embodiment includes the projector 15 described above and the imaging device 710 that images the projection image Px of the infrared light I projected from the projector 15. The projector 15 includes the movement mechanism 720 that moves the projection optical system 600 to change a position of the projection image Px, and the control unit 730 that controls the movement mechanism 720 based on the image imaged by the imaging device 710. In the projection system 16 according to the embodiment, it is possible to move the projection optical system 600 to an optimal position with high accuracy by using the control unit 730.

The projection system 16 according to the embodiment includes the projector 15 described above and the imaging device 710 that images the projection image Px of the infrared light I projected from the projector 15. The projector 15 includes the control unit 730 that changes a region of an image formed in an image display region of the first liquid crystal panel 400G based on the image imaged by the imaging device 710. In the projection system 16 according to the embodiment, it is possible to change a region of an image of the first liquid crystal panel 400G and move a projection image to an optimal position by using the control unit 730.

Although a transmissive projector is described in the embodiment, the above-described configuration may be applied to a reflective projector. The term “transmissive” refers to that a liquid crystal panel is of a type that transmits light. The term “reflective” refers to that a liquid crystal panel is of a type that reflects light.

### MODIFICATIONS

Hereinafter, modifications of the embodiment described above will be described. In description of each modification described below, the same components as those of the embodiment described above are denoted by the same reference numerals, and description thereof will be omitted.

### Modification 1

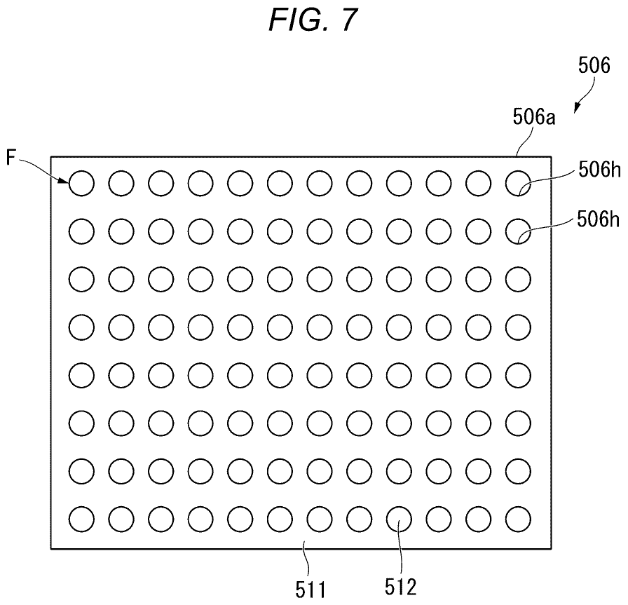

FIG. 7 is a plane schematic view showing a light transmitting member 506 according to a modification. Similar to the embodiment described above, the light transmitting member 506 is disposed on the optical path of the first combined light C1 and between the first incident-side polarizing plate 410G and the first emission-side polarizing plate 420G. Similar to the embodiment described above, the light transmitting member 506 includes the shielding portion 511 and the plurality of transmission portions 512. The shielding portion 511 shields the infrared light I by reflecting the infrared light I and transmits visible light (in particular, the green light G in the modification). On the other hand, the transmission portions 512 transmit both the infrared light I and the visible light. The transmission portions 512 are arranged in the predetermined pattern F (dot-shaped pattern).

The light transmitting member 506 according to the modification includes a shielding plate 506a. The shielding plate 506a shields the infrared light I by reflecting or absorbing the infrared light I. The shielding plate 506a transmits the visible light such as the green light G. The shielding plate 506a is manufactured by forming a shielding film that shields the infrared light I and transmits the visible light such as the green light G on a surface of a base material made of quartz glass. The shielding plate 506a is provided with a plurality of through holes 506h. The through holes 506h constitute the predetermined pattern F for forming the transmission portions 512.

According to the modification, the light transmitting member 506 can be easily manufactured by providing the through holes 506h in the shielding plate 506a that is film-formed on the base material. Therefore, manufacturing costs of the projector 15 can be reduced.

In the light transmitting member 506 according to the modification, when a thickness of the shielding plate 506a is large, reflection of the visible light may occur at an inner edge of the through hole 506h. Therefore, it is preferable that the thickness of the shielding plate 506a is fairly small. More specifically, the shielding plate 506a is preferably 1 mm or less.

### Modification 2

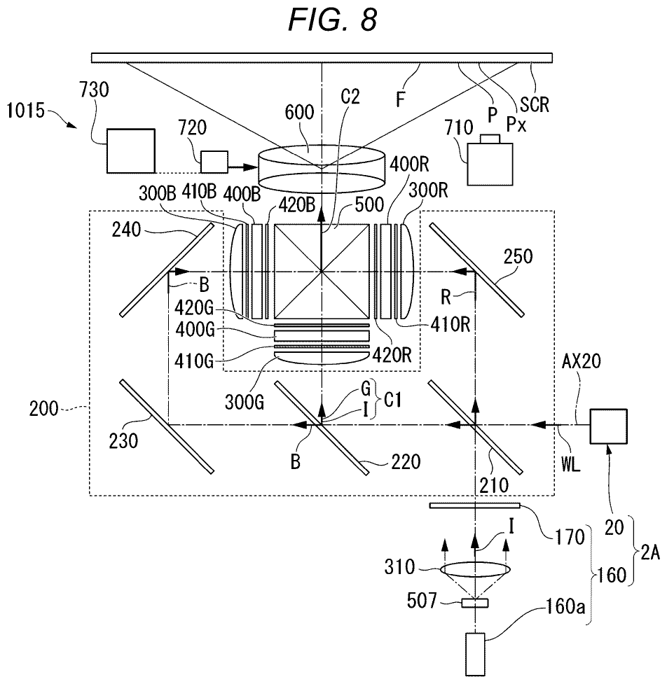

FIG. 8 is a schematic view showing a configuration of a projector 1015 according to Modification 2. The projector 1015 according to the modification is different from the projector according to the embodiment described above in a configuration for forming the predetermined pattern F of the infrared light I and a configuration of an invisible light source device 160.

As compared with the embodiment described above, the projector 1015 according to the modification does not include the light transmitting member 505, and forms the pattern F by a diffractive optical element 507. That is, the projector 1015 according to the modification includes the diffractive optical element 507 and a collimating lens 310 instead of the light transmitting member 505.

In the projector 1015 according to the modification, the diffractive optical element 507 and the collimating lens 310 are disposed on the optical path of the infrared light I and between the invisible light source device 160 and the second dichroic mirror 220. The diffractive optical element 507 diffracts the transmitted infrared light I to form the predetermined pattern F. The predetermined pattern F is determined by a surface pattern of the diffractive optical element 507. The collimating lens 310 collimates the infrared light I emitted from the diffractive optical element 507.

The infrared light I emitted from the diffractive optical element 507 is collimated by the collimating lens 310, and then is transmitted through the second dichroic mirror 220, the field lens 300G, the first incident-side polarizing plate 410G, the first liquid crystal panel 400G, the first emission-side polarizing plate 420G, and the cross dichroic prism 500, and is incident on the projection optical system 600. An image of the predetermined pattern F of the infrared light I formed by the diffractive optical element 507 is formed in the vicinity of the first liquid crystal panel 400G and between the first incident-side polarizing plate 410G and the first emission-side polarizing plate 420G. The infrared light I projected by the projection optical system 600 includes the predetermined pattern F.

In the diffractive optical element 507 according to the modification, the dot-shaped pattern F can be formed by a relatively simple surface pattern. Since the diffractive optical element 507 forms an image of the predetermined pattern Fin the air, it is not necessary to dispose a light transmitting member on the optical path of the visible light, and a reduction in a light amount of the visible light can be prevented, as compared with the embodiment described above.

In order to form the predetermined pattern F of the invisible light by the diffractive optical element 507, it is preferable to use coherent light (for example, laser light) as light incident on the diffractive optical element 507. By making coherent light incident on the diffractive optical element 507, the pattern F having a desired shape can be formed by the diffractive optical element 507 without diffusing the light.

The diffractive optical element 507 according to the modification is less likely to transmit visible light. According to the modification, since the diffractive optical element 507 is disposed between the invisible light source device 160 and the second dichroic mirror 220, the diffractive optical element 507 does not prevent transmission of visible light.

A light source device unit 2A according to the modification includes the visible light source device 20 that emits visible light (the white light WL) containing the first light (the green light G) and the invisible light source device 160 that emits invisible light (the infrared light I) in a similar manner to the embodiment described above. The invisible light source device 160 according to the modification includes a laser light source 160a and a depolarizing plate 170 that depolarizes the infrared light I emitted from the laser light source 160a.

The laser light source 160a is more easily compatible with high output than a light emitting diode light source. According to the modification, it is possible to increase a contrast ratio of the projection image Px of the infrared light I projected on the screen SCR, it is possible to increase identifiability by the imaging device 710, and it is possible to increase accuracy of position correction as compared with the embodiment described above. Further, the laser light source 160a is good in energy efficiency as compared with the light emitting diode light source. According to the modification, power saving of the projector 1015 can be achieved.

The depolarizing plate 170 is disposed on the optical path of the infrared light I and transmits the infrared light I. The depolarizing plate 170 depolarizes the transmitted infrared light I. The infrared light I emitted from the laser light source 160a is incident on the depolarizing plate 170. The infrared light I emitted from the laser light source 160a is polarized in a biased manner, and is, for example, in a linearly polarizing state. Since the invisible light source device 160 according to the modification includes the depolarizing plate 170, even when the laser light source 160a is used as a light source, the emitted infrared light I can be made in a non-polarizing state. Therefore, it is possible to prevent the infrared light I from being affected by the modulation of the first liquid crystal panel 400G, and it is easy to improve recognition accuracy of the infrared light I projected on the screen SCR.

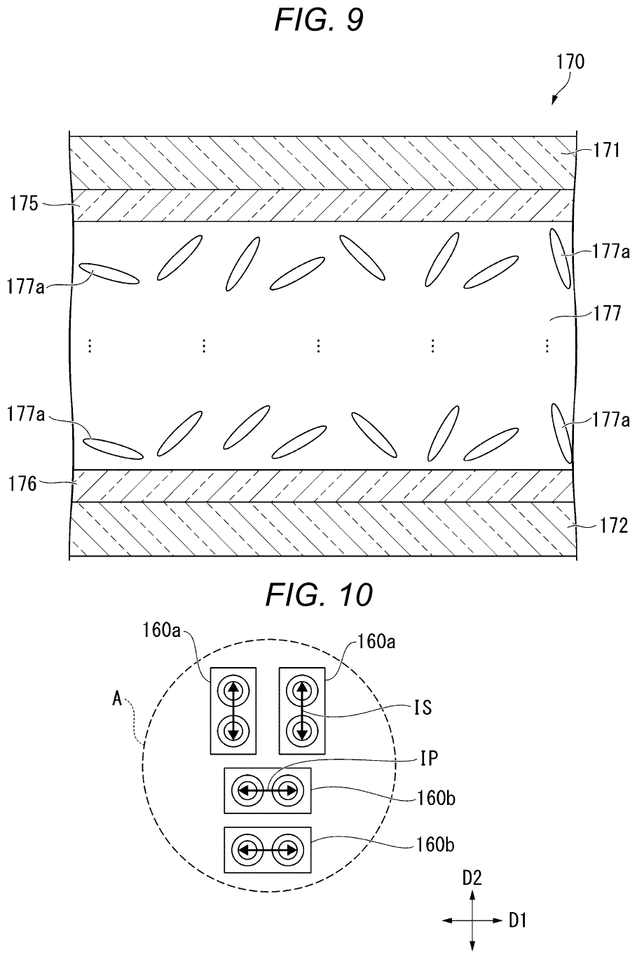

FIG. 9 is a schematic cross-sectional view showing the depolarizing plate 170 according to the modification. The depolarizing plate 170 includes a first substrate 171, a first organic film 175, a liquid crystal layer 177, a second organic film 176, and a second substrate 172. The first substrate 171, the first organic film 175, the liquid crystal layer 177, the second organic film 176, and the second substrate 172 are stacked in this order along a thickness direction of the depolarizing plate 170.

Each of the first substrate 171 and the second substrate 172 is a light transmitting base material made of quartz glass. The first organic film 175 is stacked on the first substrate 171. The second organic film 176 is stacked on the second substrate 172. Each of the first organic film 175 and the second organic film 176 is a polyimide film that was not subjected to rubbing treatment. Therefore, each of the first organic film 175 and the second organic film 176 has no orientation regulating force that regulates orientation directions of liquid crystal molecules. That is, each of the first organic film 175 and the second organic film 176 has no orientation regulating force that orients the liquid crystal molecules in one direction to align orientations of the liquid crystal molecules.

The liquid crystal layer 177 is disposed between the first organic film 175 and the second organic film 176. As described above, each of the first organic film 175 and the second organic film 176 that sandwich the liquid crystal layer 177 has no orientation regulating force. Therefore, a plurality of liquid crystal molecules 177a which constitute the liquid crystal layer 177 have random orientation directions. For example, the plurality of liquid crystal molecules 177a are randomly oriented in a plane orthogonal to the first substrate 171 or the second substrate 172, as described above. That is, the liquid crystal layer 177 contains the liquid crystal molecules arranged with the major axis directions thereof being oriented disorderly relative to the first organic film 175 and the second organic film 176.

According to the depolarizing plate 170 in the modification, the liquid crystal molecules of the liquid crystal layer 177 are arranged in a state in which the major axis directions are randomly oriented. When light is incident on the depolarizing plate 170 having a such configuration, a random phase difference is given to the light passing through the liquid crystal layer 177. Therefore, light emitted from the depolarizing plate 170 can be made in a non-polarizing state.

As described above, the depolarizing plate 170 according to the modification is of a liquid crystal type. The depolarizing plate 170 of the liquid crystal type has a very high depolarization degree. Therefore, it is easy to prevent the infrared light I from being affected by the modulation of the first liquid crystal panel 400G, and it is easy to improve recognition accuracy of the projection image Px of the infrared light I projected on the screen SCR.

In the modification, the depolarizing plate 170 may be omitted by using two laser light sources (the first laser light source 160a and a second laser light source 160b) that emit S-polarized light and P-polarized light. FIG. 10 is a schematic view showing the first laser light source 160a and the second laser light source 160b that can be adopted in the modification, as viewed from an optical axis direction. As shown in FIG. 10, the invisible light source device 160 may include, for example, two first laser light sources 160a and two second laser light sources 160b. The two first laser light sources 160a are disposed along a D1 direction orthogonal to an optical axis of the invisible light source device 160. The first laser light sources 160a emit infrared S-polarized light IS. The two second laser light sources 160b are disposed along a D2 direction orthogonal to the optical axis and the D1 direction. The second laser light sources 160b emit infrared P-polarized light IP. In FIG. 10, vibration directions of the infrared S-polarized light IS and the infrared P-polarized light IP are indicated by arrows. The two first laser light sources 160a and the two second laser light sources 160b are relatively disposed in a light emitting region A of the invisible light source device 160.

FIG. 11 is a diagram showing a polarizing state of the infrared light I emitted from the laser light sources 160a and 160b using the Poincare sphere. As shown in FIG. 11, plots of the infrared light I emitted from the invisible light source device 160 on the Poincare sphere are symmetric relative to the center.

According to the modification, the first laser light source 160a is disposed along the D1 direction which is a first direction orthogonal to the optical axis of the invisible light source device 160, and emits the infrared S-polarized light IS which is first light in a first polarization direction. The second laser light source 160b is disposed along the D2 direction orthogonal to the optical axis, and emits the infrared P-polarized light IP which is first light in a second polarization direction. According to this configuration, the invisible light source device 160 can emit the infrared light I including the infrared S-polarized light IS and the infrared P-polarized light IP while increasing a light amount of the emitted infrared light I, and the depolarizing plate 170 can be omitted.

### Modification 3

FIG. 12 is a schematic view showing a configuration of a projector 2015 according to Modification 3. The projector 2015 according to the modification is mainly different from the embodiment described above in that the first light sharing an optical path with the infrared light I is the red light R.

A color separation optical system 2200 of the projector 2015 according to the modification further includes a third dichroic mirror (optical element, second light combining element) 1250 as compared with the embodiment described above. The third dichroic mirror 1250 is disposed on an optical path of the red light R and between the first dichroic mirror 210 and the third reflection mirror 250. The third reflection mirror faces the invisible light source device 150 that emits the infrared light I. The third dichroic mirror 1250 combines the red light R and the infrared light I by reflecting the infrared light I emitted from the invisible light source device 150. That is, the third dichroic mirror 1250 transmits the red light R and reflects the infrared light I to combine the red light R and the infrared light I into first combined light C3.

In the modification, the second liquid crystal panel 400R performs the same function as the first liquid crystal panel 400G in the embodiment described above. That is, the second liquid crystal panel 400R modulates the first combined light C3. In the modification, the second incident-side polarizing plate 410R transmits the first combined light C3 on a light incident side of the second liquid crystal panel 400R. The second incident-side polarizing plate 410R transmits the first combined light C3 on a light emission side of the second liquid crystal panel 400R. Further, the light transmitting member 505 is provided on an optical path of the first combined light C3 and between the second incident-side polarizing plate 410R and the second emission-side polarizing plate 420R.

In the modification, the second incident-side polarizing plate 410R is an organic polarizing plate. The second incident-side polarizing plate 410R polarizes and transmits the red light R, and transmits the infrared light I without polarizing the infrared light I. On the other hand, the second emission-side polarizing plate 420R polarizes and transmits the red light R and the infrared light I. According to the modification, the infrared light I is not affected by the modulation of the second liquid crystal panel 400R, and the infrared light I can be sufficiently projected forward from the projection optical system 600.

In the projector 2015 according to the modification, the third dichroic mirror 1250 serving as the optical element reflects the infrared light I to thereby emit the first combined light C3. That is, the infrared light I is not transmitted through the third dichroic mirror 1250, and disturbance of polarization of the infrared light I caused by being transmitted through the third dichroic mirror 1250 can be prevented. Accordingly, the infrared light I can be incident on the second liquid crystal panel 400R while maintaining the non-polarizing state, and the infrared light I can be prevented from being affected by the modulation of the second liquid crystal panel 400R.

In the projector 2015 according to the modification, the invisible light is the infrared light I, and the first light sharing the optical path with the infrared light is the red light R. The red light R has a wavelength closest to the infrared light I among light of the three primary colors for forming a projection image. In the projector 2015 according to the modification, since the infrared light I and the red light R constituting the first combined light C3 have wavelengths close to each other, it is easy to improve reflection performance of a reflection surface that reflects the first combined light C3 in the cross dichroic prism 500. As a result, a light amount of the infrared light I emitted from the cross dichroic prism 500 is easily increased, and recognition accuracy of the projection image Px of the infrared light I projected on the screen SCR is easily increased.

According to the modification, the light transmitting member 505 is not disposed on the optical path of the green light G. Therefore, it is possible to prevent a decrease in a light amount of the green light G having high visibility. Accordingly, it is easy to ensure brightness of the projection image P of the visible light projected from the projector 2015.

The arrangement of the third dichroic mirror 1250 on which the infrared light I is incident is not limited to the modification. For example, the third dichroic mirror 1250 may be disposed on the optical path of the red light R and between the third reflection mirror 250 and the field lens 300R (a point A1 in FIG. 12). That is, the third dichroic mirror 1250 may be disposed on the optical path of the red light R.

Further, the arrangement of the second incident-side polarizing plate 410R that transmits the red light R is not limited to the modification. For example, when the third dichroic mirror 1250 is disposed at the point A1 as described above, the second incident-side polarizing plate 410R may be disposed between the third reflection mirror 250 and the point A1 (a point A2 in FIG. 12). In this case, the red light R before being combined with the infrared light I is incident on the second incident-side polarizing plate 410R. Therefore, an inorganic polarizing plate can be adopted as the second incident-side polarizing plate 410R.

### Modification 4

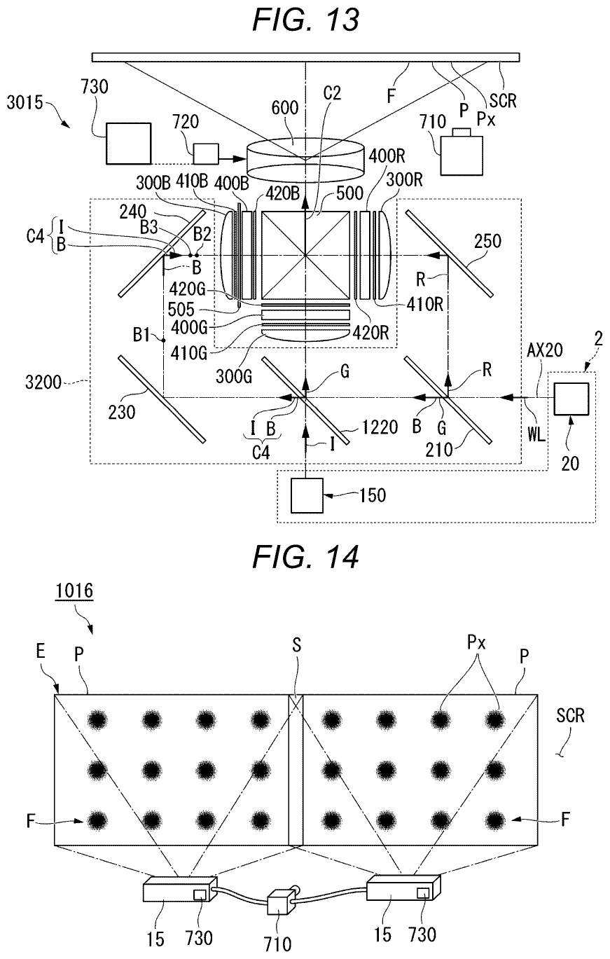

FIG. 13 is a schematic view showing a configuration of a projector 3015 according to Modification 4. The projector 3015 according to the modification is mainly different from the embodiment described above in that the first light sharing an optical path with the infrared light I is the blue light B.

A color separation optical system 3200 of the projector 3015 according to the modification includes a fourth dichroic mirror (optical element, second light combining element) 1220 instead of the second dichroic mirror 220 in the embodiment described above. The fourth dichroic mirror 1220 faces the invisible light source device 150 that emits the infrared light I. Similar to the second dichroic mirror 220 in the embodiment described above, the fourth dichroic mirror 1220 separates the green light G and the blue light B from each other. Further, the fourth dichroic mirror 1220 combines the blue light B and the infrared light I by reflecting the infrared light I emitted from the invisible light source device 150. That is, the fourth dichroic mirror 1220 transmits the blue light B and reflects the infrared light I to combine the blue light B and the infrared light I into first combined light C4.

In the modification, the third liquid crystal panel 400B performs the same function as the first liquid crystal panel 400G in the embodiment described above. That is, the third liquid crystal panel 400B modulates the first combined light C4. In the modification, the third incident-side polarizing plate 410B transmits the first combined light C4 on a light incident side of the third liquid crystal panel 400B. The third incident-side polarizing plate 410B transmits the first combined light C4 on a light emission side of the third liquid crystal panel 400B. Further, the light transmitting member 505 is provided on an optical path of the first combined light C4 and between the third incident-side polarizing plate 410B and the third emission-side polarizing plate 420B.

In the modification, the third incident-side polarizing plate 410B is an organic polarizing plate. Therefore, the third incident-side polarizing plate 410B polarizes and transmits the blue light B, and transmits the infrared light I without polarizing the infrared light I. On the other hand, the third emission-side polarizing plate 420B polarizes and transmits the blue light B and the infrared light I. According to the modification, the infrared light I is not affected by the modulation of the third liquid crystal panel 400B, and the infrared light I can be sufficiently projected forward from the projection optical system 600.

In the projector 3015 according to the modification, the fourth dichroic mirror 1220 serving as the optical element reflects the infrared light I to thereby emit the first combined light C4. That is, the infrared light I is not transmitted through the fourth dichroic mirror 1220, and disturbance of polarization of the infrared light I caused by being transmitted through the fourth dichroic mirror 1220 can be prevented. Accordingly, the infrared light I can be incident on the third liquid crystal panel 400B while maintaining the non-polarizing state, and the infrared light I can be prevented from being affected by the modulation of the third liquid crystal panel 400B.

In the modification, the light transmitting member 505 through which the first combined light C4 is transmitted has the same configuration as that in the embodiment described above. That is, as shown in FIG. 3, the light transmitting member 505 includes the shielding film 505c that transmits the visible light and shields the infrared light I by reflecting the infrared light I. An edge portion 505d having a reduced film thickness may be formed on an outer edge of the shielding film 505c. In the shielding film 505c, a function of transmitting the visible light in the edge portion 505d may be low, and a part of the visible light having a wavelength close to the wavelength of the infrared light I may be reflected. In this case, a light amount of the visible light transmitted through the light transmitting member 505 is reduced at an outer edge of the pattern F of the infrared light I.

In the projector 3015 according to the modification, the invisible light is the infrared light I, and the first light sharing an optical path with the infrared light is the blue light B. The blue light B has a wavelength farthest from the infrared light I among light of the three primary colors for forming a projection image. Therefore, the blue light B is less likely to be reflected by the edge portion 505d of the shielding film 505c, and it is possible to prevent a partial decrease in the light amount of the blue light B when the blue light B is transmitted through the light transmitting member 505. Further, the blue light B is light having relatively low visibility among the three primary colors. Therefore, even when a light amount partially decreases in an image of the blue light B due to the influence of the edge portion 505d, a viewer is less likely to recognize the decrease.

According to the modification, the light transmitting member 505 is not disposed on the optical path of the green light G, and it is possible to prevent a decrease in a light amount of the green light G having high visibility. Accordingly, it is possible to ensure brightness of the projection image P of the visible light projected from the projector 3015.

A case is described in the modification where the fourth dichroic mirror 1220 is disposed instead of the second dichroic mirror 220 in the embodiment described above. Alternatively, in addition to the second dichroic mirror 220 in the embodiment described above, the fourth dichroic mirror 1220 on which the infrared light I is incident may be separately disposed. In this case, the fourth dichroic mirror 1220 may be disposed on the optical path of the blue light B, for example, between the first reflection mirror 230 and the second reflection mirror 240 (a point B1 in FIG. 13) or between the second reflection mirror 240 and the field lens 300B (a point B2 in FIG. 13).

Further, the arrangement of the third incident-side polarizing plate 410B that transmits the blue light B is not limited to the modification. For example, when the fourth dichroic mirror 1220 is disposed at the point B2 as described above, the third incident-side polarizing plate 410B may be disposed between the second reflection mirror 240 and the point B2 (a point B3 in FIG. 12) or between the first reflection mirror 230 and the second reflection mirror 240 (the point B1 in FIG. 13). In this case, the blue light B before being combined with the infrared light I is incident on the third incident-side polarizing plate 410B. Therefore, an inorganic polarizing plate can be adopted as the third incident-side polarizing plate 410B.

### Modification 5

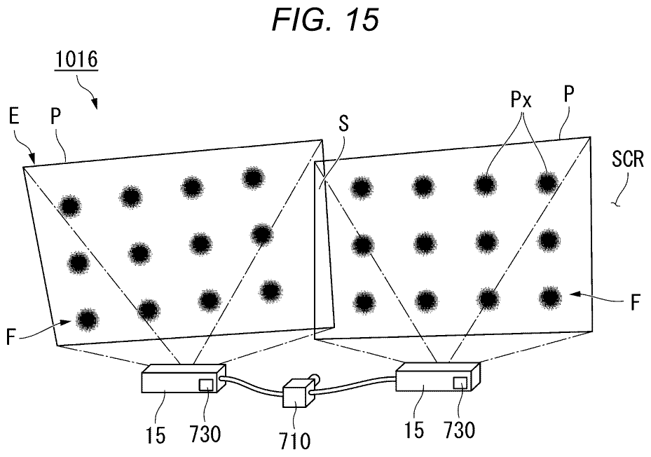

FIGS. 14 and 15 are schematic views showing a projection system 1016 according to a modification using the projector 15 described above. FIG. 14 shows the projection image P in an initial state or after image correction is performed, and FIG. 15 shows the projection image P before image correction is performed.

As shown in FIG. 14, the projection system 1016 according to the modification includes a plurality of (two in the modification) the projectors 15 and one imaging device 710. In the projection system 1016 according to the modification, the projection images P respectively projected from the plurality of projectors 15 toward one screen SCR are arranged in a left and right direction to form one extended image E extended in the left and right direction. The projection image P projected from each of the projectors 15 forms each part of the extended image E. Therefore, the respective projectors 15 cause the respective control units 730 to function in cooperation with one another to generate the projection images P in cooperation with one another.

The projection images P of the plurality of projectors 15 form an overlapping portion S on the screen SCR. The plurality of projection images P overlap one another in the overlapping portion S. By providing the overlapping portion S, the projection system 1016 can form, on the screen SCR, the extended image E having no discontinuities at seam between the projection images P. However, when the projection system 1016 is continuously used, a position of each projection image P changes due to a change in an environmental temperature around the projector 15, a change in an internal temperature caused by internal heat generation, and the like. In general, a position change amount of the projection image P is required to be less than 1.5 pixels. Therefore, as shown in FIG. 15, the overlapping portion S may be deformed, and natural coupling of the plurality of projection images P may be impaired.

In the projection system 1016 according to the modification, the control unit 730 of each of the projectors 15 is coupled to the imaging device 710. The projection image Px of the infrared light I is superimposed on the projection image P of the visible light projected from each of the projectors 15. The imaging device 710 images the projection image Px of the infrared light I with the entire extended image E included in the angle of view. That is, the imaging device 710 simultaneously images the projection images Px of the infrared light I projected from the plurality of projectors 15.

In each of the projectors 15, the control unit 730 corrects a position of the projection image P based on the projection image Px of the infrared light I imaged by the imaging device 710. In the modification, the plurality of control units 730 perform position correction for an image in cooperation with one another. Accordingly, the control unit 730 of each of the projectors 15 adjusts a shape of the overlapping portion S of the projection images P projected from the projectors 15.

In each of the projectors 15, the control unit 730 operates the movement mechanism 720 to move the projection optical system 600 of each projector 15 and corrects a position of the projection image P to adjust a shape and a size of the overlapping portion S. The control unit 730 may adjust the shape of the overlapping portion S by changing a region of an image formed in an image display region of each of the liquid crystal panels 400R, 400G, and 400B of each projector 15 and correcting the position of the projection image P.

In the projection system 1016 according to the modification, it is possible to move the projection optical system 600 to an optimal position with high accuracy by using the control unit 730. Accordingly, the number of pixels of the overlapping portion S in a direction (the left and right direction) in which the projection images P are arranged can be made less than 1.5, and a viewer can recognize the naturally extended image E. Further, even when positions of a plurality of the projection images P change over time due to heat generation or the like, it is possible to correct the changed projection images P and prevent deformation of the overlapping portion S.

In the projection system 1016, the projection images P may be arranged in an up and down direction as one extended image E. The number of projectors 15 constituting the projection system 1016 may be three or more, and in this case, a plurality of projection images P arranged in the up and down and left and right directions may be one extended image E. Further, the number of the imaging devices 710 constituting the projection system 1016 may be two or more.

### Second Embodiment

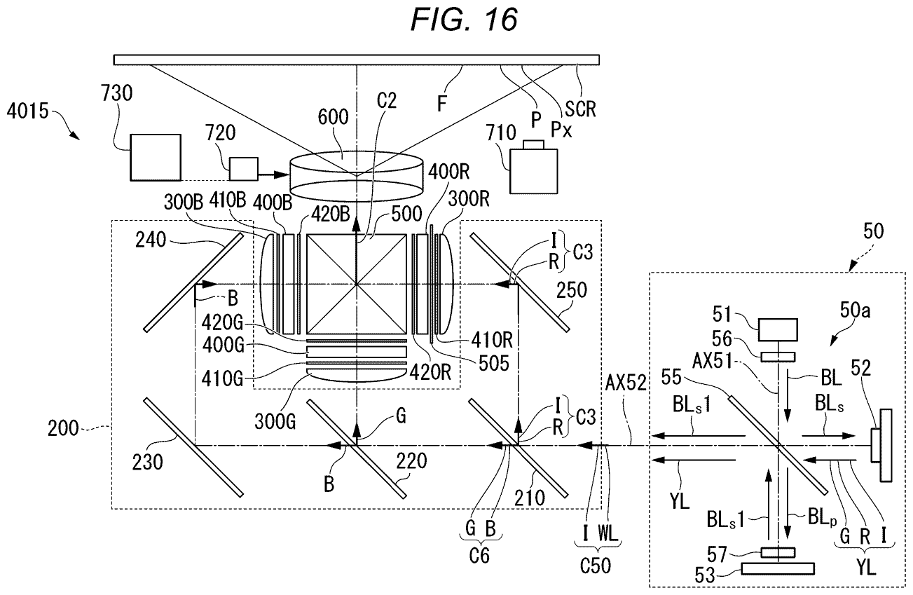

FIG. 16 is a schematic view showing a configuration of a projector 4015 of a drive device according to a second embodiment. The projector 4015 according to the embodiment is mainly different from the embodiment described above in the configuration of the light source device unit 50 and in that the first light sharing an optical path with the infrared light I is the red light R.

In the following description of the second embodiment, the same components as those of the embodiment and modifications thereof described above are denoted by the same reference numerals, and description thereof will be omitted.

The light source device unit 50 according to the embodiment includes one light source device 50a. The light source device 50a includes a laser light source 51, a first phase difference plate 56, a polarization separation element 55, a second phase difference plate 57, a phosphor element 52, and a diffusion reflection element 53. Although not shown in FIG. 16, an optical system for condensing light or an optical system for converting light into parallel light is disposed in each portion on an optical path of the light source device unit 50 as necessary.

The laser light source 51, the first phase difference plate 56, the polarization separation element 55, the second phase difference plate 57, and the diffusion reflection element 53 are sequentially arranged on a first optical axis AX51. On the other hand, the phosphor element 52 and the polarization separation element 55 are arranged on a second optical axis AX52. The first optical axis AX51 and the second optical axis AX52 are present in the same plane and are orthogonal to each other.

The laser light source 51 emits a blue light beam BL. The light beam BL emitted from the laser light source 51 is incident on the first phase difference plate 56. The first phase difference plate 56 is, for example, a rotatable ½ wave plate. The light beam BL emitted from the laser light source 51 is linearly polarized light. By appropriately setting a rotation angle of the first phase difference plate 56, the light beam BL transmitted through the first phase difference plate 56 can be made a light beam containing an S-polarized component and a P-polarized component, which are mixed with each other at a predetermined ratio and are polarized with respect to the polarization separation element 55.

The light beam BL, which is generated by being transmitted through the first phase difference plate 56 and therefore contains the S-polarized component and the P-polarized component, is incident on the polarization separation element 55. The polarization separation element 55 is implemented by, for example, a polarizing beam splitter having wavelength selectivity. The polarization separation element 55 is inclined by an angle of 45° relative to the first optical axis AX51 and the second optical axis AX52.

The polarization separation element 55 has a polarization separation function of separating the light beam BL into a light beam BLs of an S-polarized component and a light beam BLₚ of a P-polarized component with respect to the polarization separation element 55. Specifically, the polarization separation element 55 reflects the light beam BLs of the S-polarized component and transmits the light beam BLₚ of the P-polarized component. Further, the polarization separation element 55 has a color separation function of transmitting fluorescence YL, which belongs to a wavelength band different from that of the light beam BL, regardless of a polarizing state of the fluorescence YL.

The light beam BLs of the S-polarized component emitted from the polarization separation element 55 along the second optical axis AX52 is incident on the phosphor element 52.

The phosphor element 52 generates the fluorescence YL when the light beam BLs is incident on the fluorescence element 52. The fluorescence YL generated by the phosphor element 52 is emitted from the phosphor element 52 along the second optical axis AX52. The fluorescence YL emitted from the phosphor element 52 is incident on the polarization separation element 55 and is transmitted through the polarization separation element 55.

The light beam BLₚ of the P-polarized component emitted from the polarization separation element 55 along the first optical axis AX51 is incident on the second phase difference plate 57.

The second phase difference plate 57 is implemented by a ¼ wave plate disposed on an optical path between the polarization separation element 55 and the diffusion reflection element 53. Therefore, the light beam BLₚ of the P-polarized component emitted from the polarization separation element 55 is converted into, for example, right-handed circularly polarized light by the second phase difference plate 57 and then is incident on the diffusion reflection element 53. The diffusion reflection element 53 diffusely reflects the light toward the polarization separation element 55. It is preferable to use the diffusion reflection element 53 that reflects light in a Lambertian manner without disturbing a polarizing state. The diffusion reflection element 53 reflects the right-handed circularly polarized light as left-handed circularly polarized light. The light is transmitted through the second phase difference plate 57 and is converted into S-polarized blue light BLₛ1. The S-polarized blue light BLₛ1 is reflected by the polarization separation element 55 toward the first dichroic mirror 210.

The blue light BLₛ1 is combined with the fluorescence YL transmitted through the polarization separation element 55. That is, the blue light BLₛ1 and the fluorescence YL are emitted from the polarization separation element 55 in the same direction to form the white light WL in which the blue light BLₛ1 and the fluorescence (yellow light) YL are mixed with each other.

In the embodiment, the fluorescence YL emitted from the phosphor element 52 contains not only the green light G and the red light R but also the infrared light I. That is, the phosphor element 52 converts the light emitted from the laser light source 51 into light containing the red light R serving as the first light and the infrared light I serving as the invisible light. As described above, the phosphor element 52 is, for example, an oxide phosphor containing an alkali metal element, an alkaline earth metal element, an element of Group 13 of the periodic table, O, Cr, at least an element selected from Si, Ti, Ge, Zr, Sn, Hf, and Pb, and the like at a predetermined ratio.

According to the embodiment, since the fluorescence YL contains the infrared light I, emitted light obtained by combining the fluorescence YL and the blue light BLs 1 is light obtained by combining the infrared light I with the white light WL serving as visible light. That is, the light source device unit 50 according to the embodiment emits combined light containing the white light WL and the infrared light I. Here, the combined light emitted from the light source device unit 50 is referred to as third combined light C50. The third combined light C50 contains the red light R, the green light G, the blue light B, and the infrared light I.

The third combined light C50 emitted from the light source device unit 50 is incident on the first dichroic mirror 210. In the embodiment, the first dichroic mirror 210 reflects light having a wavelength equal to or larger than the red light R and transmits light having a wavelength smaller than the red light R. That is, the first dichroic mirror 210 reflects the red light R and the infrared light I contained in the third combined light C50, and transmits the green light G and the blue light B. The red light R and the infrared light I emitted from the first dichroic mirror 210 constitute first combined light C3. The first dichroic mirror 210 in the embodiment functions as a light separation element that separates the green light G and the blue light B from the third combined light C50 and emits the first combined light C3.

In the projector 4015 according to the embodiment, the first dichroic mirror 210 serving as an optical element reflects the infrared light I to thereby emit the first combined light C3. Therefore, the infrared light I is not transmitted through the optical element, and it is possible to prevent disturbance of polarization of the infrared light I caused by being transmitted through the optical element. Accordingly, the infrared light I can be incident on the second liquid crystal panel 400R while maintaining a non-polarizing state. As a result, the infrared light I is not affected by the modulation in the second liquid crystal panel 400R, and the infrared light I can be sufficiently projected forward from the projection optical system 600.

The first combined light C3 emitted from the first dichroic mirror 210 is reflected by the third reflection mirror 250 and guided to the second liquid crystal panel 400R. In the embodiment, the second liquid crystal panel 400R performs the same function as the first liquid crystal panel 400G in the first embodiment. That is, the second liquid crystal panel 400R modulates the first combined light C3. In the embodiment, the second incident-side polarizing plate 410R transmits the first combined light C3 on a light incident side of the second liquid crystal panel 400R. The second incident-side polarizing plate 410R transmits the first combined light C3 on a light emission side of the second liquid crystal panel 400R. Further, the light transmitting member 505 is provided on an optical path of the first combined light C3 and between the second incident-side polarizing plate 410R and the second emission-side polarizing plate 420R.

In the embodiment, the second incident-side polarizing plate 410R is an organic polarizing plate. The second incident-side polarizing plate 410R polarizes and transmits the red light R, and transmits the infrared light I without polarizing the infrared light I. On the other hand, the second emission-side polarizing plate 420R polarizes and transmits the red light R and the infrared light I. According to the embodiment, the infrared light I is not affected by the modulation of the second liquid crystal panel 400R, and the infrared light I can be sufficiently projected forward from the projection optical system 600.

In the projector 4015 according to the embodiment, the invisible light is the infrared light I, and the first light sharing the optical path with the infrared light is the red light R. That is, the invisible light and the first light have wavelengths close to each other. Therefore, in the first dichroic mirror 210, it is easy to improve reflection performance when separating light (the green light G and the blue light B) having other wavelengths. Further, it is easy to improve reflection performance of a reflection surface that reflects the first combined light C3 in the cross dichroic prism 500. As a result, a light amount of the infrared light I emitted from the cross dichroic prism 500 is easily increased, and recognition accuracy of the projection image Px of the infrared light I projected on the screen SCR is easily increased.

In the projector 4015 according to the embodiment, the light source device unit 50 includes the light source device 50a that emits the third combined light C50 containing the red light R serving as the first light, the green light G serving as the second light, the blue light B serving as the third light, and the infrared light I serving as the invisible light. The first dichroic mirror 210 serving as an optical element separates the third combined light C50 into fourth combined light C6, which contains the green light G and the blue light B, and first combined light C3, which contains the red light R and the infrared light I. According to the embodiment, the light source device unit 50 can simultaneously generate and emit visible light and invisible light by one light source device 50a, and it is not necessary to provide a plurality of light source devices. Therefore, the projector 4015 can be manufactured at lower cost than in a case where the light source device unit includes a plurality of light source devices.

In the embodiment, the red light R forms the first combined light C3 together with the infrared light I, and is separated from the visible light having other wavelengths (the green light G and the blue light B) by the first dichroic mirror 210 serving as the optical element. The red light R is light having a wavelength closer to the infrared light I than the green light G and the blue light B. Therefore, in the first dichroic mirror 210, the first combined light C3 can be easily separated from the green light G and the blue light B.

The light source device 50a according to the embodiment includes the laser light source 51 that emits the light beam BL and the phosphor element 52 that converts the light beam BL into the fluorescence YL containing the red light R serving as the first light and the infrared light I serving as the invisible light. According to the embodiment, since the phosphor element 52 simultaneously generates and emits the red light R and the infrared light I, it is not necessary to use an optical element that combines the visible light and the infrared light I, and a configuration of the projector 4015 can be simplified.

Although preferred embodiments and modifications of the present disclosure have been described above in detail, the present disclosure is not limited to such specific embodiments and modifications, and various modifications and changes can be made within the scope of the gist of the present disclosure described in the claims. Components of a plurality of embodiments can be combined as appropriate.

### Summary of Present Disclosure

The present disclosure will be summarized below in the form of appendixes.

### Appendix 1

A projector including:
a light source device unit configured to emit invisible light and visible light containing first light having a first wavelength;
an optical element configured to emit first combined light containing the first light and the invisible light;
a first liquid crystal panel configured to modulate the first combined light;
a first incident-side polarizing plate configured to transmit the first light on a light incident side of the first liquid crystal panel;
a first emission-side polarizing plate configured to transmit the first light on a light emission side of the first liquid crystal panel; and
a projection optical system configured to project the first combined light emitted from the first liquid crystal panel, wherein
the optical element functions as at least one of a light separation element that separates, from the visible light, light having a wavelength different from the first wavelength or a light combining element that combines the first light and the invisible light, and
the invisible light is reflected by the optical element.

According to this configuration, the projector includes the invisible light source device that emits the infrared light which is invisible light separately from the visible light source device for forming the projection image. An optical path of the infrared light emitted from the invisible light source device overlaps an optical path of the visible light. Further, the visible light and the invisible light whose optical paths overlap each other pass through the common first liquid crystal panel as the first combined light and are projected from the projection optical system. Therefore, in the projector, it is possible to use the invisible light to directly track movement or deviation of the projection image due to a factor on the optical path of the visible light. As a result, a movement amount of the projection image formed by the visible light coincides with a movement amount detected from the projection image formed by the invisible light, and the projection image can be accurately adjusted based on the movement amounts. According to the configuration described above, the optical element reflects the invisible light to thereby emit the first combined light. Therefore, the invisible light is not transmitted through the optical element, disturbance of polarization of the invisible light can be prevented, and the invisible light can be incident on the first liquid crystal while maintaining a non-polarizing state. As a result, the invisible light is not affected by the modulation in the first liquid crystal panel, and the invisible light can be sufficiently projected forward from the projection optical system.

### Appendix 2

The projector according to Appendix 1, in which
the first incident-side polarizing plate is disposed on an optical path of the first combined light, and
the first incident-side polarizing plate polarizes and transmits the first light and transmits the invisible light without polarizing the invisible light.

According to this configuration, the first incident-side polarizing plate disposed on the optical path of the first combined light transmits the invisible light without polarizing the invisible light. Therefore, the invisible light is not affected by the modulation of the first liquid crystal panel after being emitted from the first incident-side polarizing plate, and the invisible light can be sufficiently projected forward from the projection optical system.

### Appendix 3

The projector according to Appendix 1 or 2, further including:
a color separation optical system configured to separate the visible light emitted from the light source device unit into the first light, second light having a second wavelength different from the first wavelength, and third light having a third wavelength different from both the first wavelength and the second wavelength;
a second liquid crystal panel configured to modulate the second light;
a third liquid crystal panel configured to modulate the third light;
a second incident-side polarizing plate configured to transmit the second light at a light incident side of the second liquid crystal panel;
a second emission-side polarizing plate configured to transmit the second light at a light emission side of the second liquid crystal panel;
a third incident-side polarizing plate configured to transmit the third light at a light incident side of the third liquid crystal panel;
a third emission-side polarizing plate configured to transmit the third light at a light emission side of the third liquid crystal panel; and
a first light combining element configured to combine the first combined light emitted from the first liquid crystal panel, the second light emitted from the second liquid crystal panel, and the third light emitted from the third liquid crystal panel into second combined light, in which
the projection optical system projects the second combined light emitted from the first light combining element.

According to this configuration, in the projector that emits image light of two or more colors, such as a three-plate projector, it is possible to project light containing invisible light forward. In the projector that emits image light of two or more colors, a viewer is likely to feel deviation of an image due to over-time deformation of a component caused by internal heat generation. According to the configuration described above, in the projector that emits image light of two or more colors, a position of an image can be corrected by the invisible light, and an effect of position correction can be made more significant.

### Appendix 4

The projector according to appendix 3, in which
the first light is green light.

According to this configuration, the first light to be combined with the invisible light to form the first combined light is the green light. The green light has highest visibility among light of the three primary colors. According to this configuration, the optical path of the invisible light is disposed in a manner of overlapping the optical path of the green light, and movement or positional deviation of a member on the optical path of the green light can be directly tracked by the invisible light. Therefore, it is possible to accurately correct a position of an image of the green light having high visibility, and it is possible to provide the projector that makes it difficult for a viewer to feel positional deviation of the image.

### Appendix 5

The projector according to Appendix 3, in which
the first light is red light, and
the invisible light is infrared light.

According to this configuration, since the visible light and the invisible light constituting the first combined light have wavelengths close to each other, it is easy to improve reflection performance (or transmission performance) of a reflection surface (or transmission surface) that reflects (or transmits) the first combined light in a cross dichroic mirror. As a result, the light amount of the invisible light is easily increased, and recognition accuracy of the projection image of the invisible light projected on the screen is easily increased.

### Appendix 6

The projector according to Appendix 5, in which
the light source device unit includes a light source device configured to emit third combined light containing the first light, the second light, the third light, and the invisible light, and
the optical element separates the third combined light into the first combined light and fourth combined light containing the second light and the third light.

According to this configuration, the light source device unit can simultaneously generate and emit the visible light and the invisible light by one light source device, and it is not necessary to provide a plurality of light source devices. Therefore, the projector can be manufactured at lower cost than in a case where the light source device unit includes a plurality of light source devices. Further, according to this configuration, light constituting the third combined light together with the infrared light is the red light having a wavelength close to the infrared light. Therefore, in the optical element, the third combined light can be easily separated from light having other wavelengths.

### Appendix 7

The projector according to Appendix 6, in which
the light source device includes
   a laser light source configured to emit a light beam, and
   a phosphor element configured to convert the light beam into light containing the first light and the invisible light.

According to this configuration, since the phosphor element simultaneously generates and emits the red light and the infrared light, it is not necessary to use an optical element that combines the phosphor and the infrared light, and a configuration of the projector can be simplified.

### Appendix 8

The projector according to Appendix 3, in which
the first light is blue light, and
the invisible light is infrared light.

According to this configuration, since the visible light transmitted through a light transmitting member is light having a wavelength far from the invisible light, the visible light is easily transmitted through a shielding portion of the light transmitting member. Therefore, a portion where a light amount decreases is less likely to occur on an irradiation surface of the visible light. Further, the blue light is light having relatively low visibility among the three primary colors. Therefore, even when a portion where a light amount decreases occurs on the irradiation surface of the visible light, a viewer is less likely to recognize the portion.

### Appendix 9

The projector according to any one of Appendixes 1 to 5 and Appendix 8, in which
the light source device unit includes
   a visible light source device configured to emit the visible light containing the first light, and
   an invisible light source device configured to emit the invisible light, and
the projector further includes, as the optical element, a second light combining element configured to combine the first light and the invisible light.

According to this configuration, the invisible light and the infrared light emitted respectively from the light source devices can be combined by the second light combining element to form the first combined light. Further, since the second light combining element forms the first combined light when the invisible light is reflected, it is possible to form the first combined light while preventing disturbance of polarization of the invisible light.

### Appendix 10

The projector according to Appendix 9, in which
the invisible light source device includes a light emitting diode light source configured to emit the invisible light.

In general, the light emitting diode light source can emit light in a non-polarizing state. According to the configuration described above, the invisible light in a non-polarizing state from the invisible light source device can be incident on the first liquid crystal panel. Therefore, the invisible light can be prevented from being affected by the modulation of the first liquid crystal panel, and it is easy to improve recognition accuracy of the invisible light projected on the screen.

### Appendix 11

The projector according to Appendix 9, in which
the invisible light source device includes a laser light source configured to emit the invisible light.

In general, the laser light source is more easily compatible with high output than the light emitting diode light source. Therefore, according to the configuration described above, it is possible to increase a contrast ratio of the projection image of the invisible light projected on the screen by the projector, it is possible to increase identifiability by an imaging device, and it is possible to increase accuracy of position correction. Further, since the laser light source is good in energy efficiency as compared with the light emitting diode light source, power saving of the projector can be achieved.

### Appendix 12

The projector according to Appendix 11, in which
the invisible light source device includes a depolarizing plate configured to transmit the invisible light emitted from the laser light source and depolarize the invisible light.

According to this configuration, since the invisible light source device includes the depolarizing plate, even when the laser light source is used as a light source, the emitted invisible light can be made in a non-polarizing state. Therefore, the invisible light can be prevented from being affected by the modulation of the first liquid crystal panel, and it is easy to improve recognition accuracy of the invisible light projected on the screen.

### Appendix 13

The projector according to Appendix 12, in which
the depolarizing plate includes
   a first substrate,
   a second substrate disposed in a manner of facing the first substrate,
   a first organic film stacked on the first substrate and having no orientation regulating force that regulates an orientation direction of a liquid crystal molecule,
   a second organic film stacked on the second substrate and having no orientation regulating force that regulates an orientation direction of a liquid crystal molecule, and
   a liquid crystal layer disposed between the first organic film and the second organic film and containing a liquid crystal molecule arranged with a major axis direction oriented disorderly with respect to the first organic film and the second organic film.

According to this configuration, a depolarizing plate of a liquid crystal type having a high depolarization degree can be used, and polarization of the invisible light emitted from the light source device unit can be easily prevented.

### Appendix 14

The projector according to any one of Appendixes 1 to 13, in which
the light source device unit emits infrared light having a wavelength of 930 nm or more and 950 nm or less.

According to this configuration, by using, as the invisible light, the infrared light having a wavelength of 930 nm or more and 950 nm or less in which solar energy is low, it is possible to prevent a decrease in contrast of a pattern of the invisible light due to the influence of sunlight when the screen is irradiated with the invisible light. As a result, it is possible to prevent a decrease in accuracy of position detection by using the pattern of the invisible light.

### Appendix 15

The projector according to any one of Appendixes 1 to 13, in which
the light source device unit emits infrared light having a wavelength of 840 nm or more and 860 nm or less.

According to this configuration, by using, as the invisible light, the infrared light having a wavelength of 840 nm or more and 860 nm or less, energy efficiency in the light source device unit can be increased, and power consumption of the projector can be reduced. Further, since a light source that emits the infrared light having a wavelength of 840 nm or more and 860 nm or less is widely used as a light source of the invisible light, it is possible to stably procure parts at low cost, and it is possible to reduce manufacturing costs of the projector.

### Appendix 16

The projector according to any one of Appendixes 1 to 15, further including:
the light transmitting member disposed between the first incident-side polarizing plate and the first emission-side polarizing plate, in which
the light transmitting member includes
   the shielding portion configured to shield the invisible light contained in the first combined light and transmit the first light, and
   a transmission portion configured to transmit both the invisible light and the first light contained in the first combined light,
the transmission portion is disposed in a predetermined pattern, and
the invisible light projected by the projection optical system includes the predetermined pattern.

According to this configuration, the invisible light of the predetermined pattern is projected on a projection surface such as a screen, and a movement amount of the projection image formed by the actual visible light can be detected with high accuracy by detecting position information or the like of the predetermined pattern.

### Appendix 17

The projector according to Appendix 16, in which
the light transmitting member includes a shielding plate configured to shield the invisible light and transmit the first light, and
the shielding plate is provided with a through hole having the predetermined pattern.

According to this configuration, the light transmitting member can be easily manufactured by providing the through hole in the shielding plate that is film-formed on a base material. Therefore, manufacturing costs of the projector can be reduced.

### Appendix 18

The projector according to Appendix 16 or 17, in which
the light source device unit includes
   a light source configured to emit the invisible light, and
   a homogenizing optical element configured to transmit the invisible light emitted from the light source and form a homogenizing irradiation pattern.

According to this configuration, a light amount of the invisible light is homogenized by being transmitted through the homogenizing optical element. Accordingly, the light source device unit can emit the invisible light with high homogenization. Accordingly, it is possible to prevent variation in an in-plane light amount caused by the light source device unit in the pattern of the invisible light formed by being transmitted through the light transmitting member. Accordingly, accuracy of position detection using the pattern of the invisible light can be improved. Further, since the infrared light can be emitted with high homogenization and a simple structure by using the homogenizing optical element, it is possible to reduce size and cost of the projector.

### Appendix 19

The projector according to any one of Appendixes 16 to 19, in which
an image forming surface by the first light in the projection optical system overlaps the first liquid crystal panel, and
an image forming surface by the invisible light in the projection optical system is deviated from the light transmitting member in an axial direction of the optical path of the first combined light.

According to this configuration, an image of a binary pattern of the invisible light formed by being transmitted through the light transmitting member is not focused on the screen, and becomes an image having an illuminance distribution close to a Gaussian distribution. Therefore, the imaging device can identify the pattern of the invisible light with high accuracy, and the projection image can be aligned with high accuracy.

### Appendix 20

The projector according to Appendix 19, in which
the image forming surface by the invisible light in the projection optical system is deviated from the light transmitting member to a side where the first liquid crystal panel is disposed.

According to this configuration, the light transmitting member is deviated from the image forming surface to a side opposite to the first liquid crystal panel. The first liquid crystal panel is not disposed between the light transmitting member and the image forming surface. Therefore, a distance between the light transmitting member and the image forming surface can be determined regardless of a positional relationship with the first liquid crystal panel, and an image of the invisible light having a more preferable illuminance distribution can be formed on the screen.

### Appendix 21

The projector according to Appendix 9 or 10, further including:
a diffractive optical element that is disposed on an optical path of the invisible light and between the invisible light source device and the second light combining element and diffracts the invisible light to form a predetermined pattern, in which
the invisible light projected by the projection optical system includes the predetermined pattern.

According to this configuration, it is possible to form a projection image of the invisible light having a dot-shaped pattern by the diffractive optical element having a relatively simple surface pattern, and it is possible to reduce manufacturing costs of the projector. In addition, since the diffractive optical element forms an image of the predetermined pattern in the air, it is not necessary to dispose the light transmitting member on the optical path of the visible light, and a reduction in the light amount of the visible light can be prevented.

### Appendix 22

A projection system including:
the projector according to any one of Appendixes 1 to 21; and
an imaging device configured to image a projection image of the invisible light projected from the projector, in which
the projector includes
   a movement mechanism configured to move the projection optical system to change a position of the projection image, and
   a control unit configured to control the movement mechanism based on an image imaged by the imaging device.

According to this configuration, it is possible to move the projection optical system to an optimal position with high accuracy by using the control unit.

### Appendix 23

A projection system including:
the projector according to any one of Appendixes 1 to 21; and
an imaging device configured to image a projection image of the invisible light projected from the projector, in which
the projector includes a control unit configured to change a region of an image formed in an image display region of the first liquid crystal panel based on an image imaged by the imaging device.

According to this configuration, it is possible to change a region of an image of the first liquid crystal panel and move a projection image to an optimal position by using the control unit.

### Appendix 24

The projection system according to Appendix 22 or 23, further including:
a plurality of the projectors, in which
the imaging device simultaneously images the invisible light of the projection images projected respectively from the plurality of projectors, and
the control unit of each of the projectors adjusts an overlapping amount of the projection images projected from the projectors.

According to this configuration, it is possible to move the projection optical system to an optimal position with high accuracy by using the control unit, it is possible to adjust an overlapping amount in a direction in which the plurality of projection images are arranged, and it is possible to enable a viewer to recognize a naturally extended image. Further, even when positions of the plurality of the projection images change over time due to heat generation or the like, it is possible to correct the changed projection images and prevent deformation of an overlapping portion.

What is claimed is:

1. A projector comprising:
a light source device unit configured to emit invisible light and visible light containing first light having a first wavelength;
an optical element configured to emit first combined light containing the first light and the invisible light;
a first liquid crystal panel configured to modulate the first combined light;
a first incident-side polarizing plate configured to transmit the first light on a light incident side of the first liquid crystal panel;
a first emission-side polarizing plate configured to transmit the first light on a light emission side of the first liquid crystal panel; and
a projection optical system configured to project the first combined light emitted from the first liquid crystal panel, wherein
the optical element functions as at least one of a light separation element that separates, from the visible light, light having a wavelength different from the first wavelength or a light combining element that combines the first light and the invisible light, and
the invisible light is reflected by the optical element.

2. The projector according to claim 1, wherein
the first incident-side polarizing plate is disposed on an optical path of the first combined light, and
the first incident-side polarizing plate polarizes and transmits the first light and transmits the invisible light without polarizing the invisible light.

3. The projector according to claim 1, further comprising:
a color separation optical system configured to separate the visible light emitted from the light source device unit into the first light, second light having a second wavelength different from the first wavelength, and third light having a third wavelength different from both the first wavelength and the second wavelength;
a second liquid crystal panel configured to modulate the second light;
a third liquid crystal panel configured to modulate the third light;
a second incident-side polarizing plate configured to transmit the second light at a light incident side of the second liquid crystal panel;
a second emission-side polarizing plate configured to transmit the second light at a light emission side of the second liquid crystal panel;
a third incident-side polarizing plate configured to transmit the third light at a light incident side of the third liquid crystal panel;
a third emission-side polarizing plate configured to transmit the third light at a light emission side of the third liquid crystal panel; and
a first light combining element configured to combine the first combined light emitted from the first liquid crystal panel, the second light emitted from the second liquid crystal panel, and the third light emitted from the third liquid crystal panel into second combined light, wherein
the projection optical system projects the second combined light emitted from the first light combining element.

4. The projector according to claim 3, wherein
the first light is green light.

5. The projector according to claim 3, wherein
the first light is red light, and
the invisible light is infrared light.

6. The projector according to claim 5, wherein
the light source device unit includes a light source device that emits third combined light containing the first light, the second light, the third light, and the invisible light, and
the optical element separates the third combined light into the first combined light and fourth combined light containing the second light and the third light.

7. The projector according to claim 6, wherein
the light source device includes
a laser light source configured to emit a light beam, and
a phosphor element configured to convert the light beam into light containing the first light and the invisible light.

8. The projector according to claim 3, wherein
the first light is blue light, and
the invisible light is infrared light.

9. The projector according to claim 1, wherein
the light source device unit includes
a visible light source device configured to emit the visible light containing the first light, and
an invisible light source device configured to emit the invisible light, and
the projector further includes, as the optical element, a second light combining element configured to combine the first light and the invisible light.

10. The projector according to claim 9, wherein
the invisible light source device includes a light emitting diode light source configured to emit the invisible light.

11. The projector according to claim 9, wherein
the invisible light source device includes a laser light source configured to emit the invisible light.

12. The projector according to claim 11, wherein
the invisible light source device includes a depolarizing plate configured to transmit the invisible light emitted from the laser light source and depolarize the invisible light.

13. The projector according to claim 12, wherein
the depolarizing plate includes
a first substrate,
a second substrate disposed in a manner of facing the first substrate,
a first organic film stacked on the first substrate and having no orientation regulating force that regulates an orientation direction of a liquid crystal molecule,
a second organic film stacked on the second substrate and having no orientation regulating force that regulates an orientation direction of a liquid crystal molecule, and
a liquid crystal layer disposed between the first organic film and the second organic film and containing a liquid crystal molecule disposed with a major axis direction oriented disorderly with respect to the first organic film and the second organic film.

14. The projector according to claim 1, wherein
the light source device unit emits infrared light having a wavelength of 930 nm or more and 950 nm or less.

15. The projector according to claim 1, wherein
the light source device unit emits infrared light having a wavelength of 840 nm or more and 860 nm or less.

16. The projector according to claim 1, further comprising:
a light transmitting member disposed between the first incident-side polarizing plate and the first emission-side polarizing plate, wherein
the light transmitting member includes
a shielding portion configured to shield the invisible light contained in the first combined light and transmit the first light, and
a transmission portion configured to transmit both the invisible light and the first light contained in the first combined light,
the transmission portion is disposed in a predetermined pattern, and
the invisible light projected by the projection optical system includes the predetermined pattern.

17. The projector according to claim 16, wherein
the light transmitting member includes a shielding plate configured to shield the invisible light and transmit the first light, and
the shielding plate is provided with a through hole having the predetermined pattern.

18. The projector according to claim 16, wherein
the light source device unit includes
a light source configured to emit the invisible light, and
a homogenizing optical element configured to transmit the invisible light emitted from the light source and form a homogenizing irradiation pattern.

19. The projector according to claim 16, wherein
an image forming surface by the first light in the projection optical system overlaps the first liquid crystal panel, and
an image forming surface by the invisible light in the projection optical system is deviated from the light transmitting member in an axial direction of an optical path of the first combined light.

20. The projector according to claim 19, wherein
the image forming surface by the invisible light in the projection optical system is deviated from the light transmitting member to a side where the first liquid crystal panel is disposed.

21. The projector according to claim 9, further comprising:
a diffractive optical element that is disposed on an optical path of the invisible light and between the invisible light source device and the second light combining element and is configured to diffract the invisible light to form a predetermined pattern, wherein
the invisible light projected by the projection optical system includes the predetermined pattern.

22. A projection system comprising:
the projector according to claim 1; and
an imaging device configured to image a projection image of the invisible light projected from the projector, wherein
the projector includes
a movement mechanism configured to move the projection optical system to change a position of the projection image, and
a control unit configured to control the movement mechanism based on an image imaged by the imaging device.

23. A projection system comprising:
the projector according to claim 1; and
an imaging device configured to image a projection image of the invisible light projected from the projector, wherein
the projector includes a control unit that changes a region of an image formed in an image display region of the first liquid crystal panel based on an image imaged by the imaging device.

24. The projection system according to claim 22, further comprising:
a plurality of the projectors, wherein
the imaging device simultaneously images the invisible light of the projection images projected respectively from the plurality of projectors, and
the control unit of each of the projectors adjusts an overlapping amount of the projection images projected from the projectors.
